(19) United States
(12) Patent Application Publication
(10) Pub. No.: US 2024/0177040 A1
(43) Pub. Date: May 30, 2024

(54) Method for Determining Fidelity of Qubit Gate in Quantum Processor, and Storage Medium

(71) Applicant: Alibaba Damo (Hangzhou) Technology Co., Ltd., Hangzhou, Zhejiang (CN)

(72) Inventors: Feng WU, Hangzhou, Zhejiang (CN); Xiaotong NI, Hangzhou, Zhejiang (CN); Huihai ZHAO, Beijing (CN)

(21) Appl. No.: 18/516,115

(22) Filed: Nov. 21, 2023

(30) Foreign Application Priority Data
Nov. 24, 2022 (CN) 202211483119.X

(51) Int. Cl. G06N 10/20; G06N 10/40

(52) U.S. Cl. CPC G06N 10/20; G06N 10/40

(57) ABSTRACT

The present disclosure discloses a method for determining fidelity of a qubit gate in a quantum processor, and a storage medium. The method includes: determining environmental qubit gates associated with a two-qubit gate in the quantum processor, where the two-qubit gate interacts with the environmental qubit gates in the quantum processor; determining a fidelity error of the environmental qubit gates based on a fidelity error of the two-qubit gate; determining frequency of the environmental qubit gates based on the fidelity error of the environmental qubit gates; and determining fidelity of the two-qubit gate based on the frequency of the environmental qubit gates. The present disclosure solves the technical problem of being unable to determine the fidelity of the two-qubit gate.

### CROSS REFERENCE TO RELATED APPLICATIONS

The disclosure claims the benefits of priority to Chinese Application No. 202211483119.X, filed on 24 Nov. 2022, which is incorporated herein by reference in its entirety.

### TECHNICAL FIELD

The present disclosure relates to the field of superconducting quantum, and in particular relates to a method for determining fidelity of a qubit gate in a quantum processor, and a storage medium.

### BACKGROUND

In the design process of quantum chips, only the fidelity of isolated two-qubit gates is considered. However, during the practical application of the quantum chips, the two-qubit gates inevitably interact with surrounding quantum bits. But there is no existing technology available to characterize the fidelity of the two-qubit gates in a multi-qubit environment currently, causing a technical problem of being unable to determine the fidelity of the two-qubit gate.

### SUMMARY

The disclosed embodiments provide a method for determining fidelity of a qubit gate in a quantum processor, and a storage medium, so as to at least solve the technical problem of being unable to determine the fidelity of a two-qubit gate.

According to some embodiments of this disclosure, a method is provided for determining fidelity of a qubit gate in a quantum processor. The method includes: determining environmental qubit gates associated with a two-qubit gate in the quantum processor, where the two-qubit gate interacts with the environmental qubit gates in the quantum processor; determining a fidelity error of the environmental qubit gates based on a fidelity error of the two-qubit gate; determining frequency of the environmental qubit gates based on the fidelity error of the environmental qubit gates; and determining fidelity of the two-qubit gate based on the frequency of the environmental qubit gates.

According to some embodiments of this disclosure, a method is provided for determining fidelity of a qubit gate in a quantum processor. The method includes: acquiring, by invoking a first interface, environmental qubit gates associated with a two-qubit gate in the quantum processor, where the first interface includes a first parameter, a parameter value of the first parameter involves the two-qubit gate and the environmental qubit gates, where the two-qubit gate interacts with the environmental qubit gates in the quantum processor; determining a fidelity error of the environmental qubit gates based on a fidelity error of the two-qubit gate; determining frequency of the environmental qubit gates based on the fidelity error of the environmental qubit gates; determining fidelity of the two-qubit gate based on the frequency of the environmental qubit gates; and outputting, by invoking a second interface, the fidelity of the two-qubit gate, where the second interface includes a second parameter, and a parameter value of the second parameter represents the fidelity of the two-qubit gate.

According to some embodiments of this disclosure, a method is provided for determining fidelity of a qubit gate in a quantum processor. The method includes: acquiring, from a quantum platform, environmental qubit gates associated with a two-qubit gate in the quantum processor, where the two-qubit gate interacts with the environmental qubit gates in the quantum processor; determining a fidelity error of the environmental qubit gates based on a fidelity error of the two-qubit gate; determining frequency of the environmental qubit gates based on the fidelity error of the environmental qubit gates; determining fidelity of the two-qubit gate based on the frequency of the environmental qubit gates; and returning the fidelity of the two-qubit gate to the quantum platform.

According to some embodiments of this disclosure, an apparatus is provided for determining fidelity of a qubit gate in a quantum processor. The apparatus includes: a memory storing instructions; and one or more processors configured to execute the instructions to cause the apparatus to perform operations including: determining environmental qubit gates associated with a two-qubit gate in the quantum processor, wherein the two-qubit gate interacts with the environmental qubit gates in the quantum processor; determining a fidelity error of the environmental qubit gates based on a fidelity error of the two-qubit gate; determining frequency of the environmental qubit gates based on the fidelity error of the environmental qubit gates; and determining fidelity of the two-qubit gate based on the frequency of the environmental qubit gates.

According to some embodiments of this disclosure, an apparatus is provided for determining fidelity of a qubit gate in a quantum processor. The apparatus includes: a memory storing instructions; and one or more processors configured to execute the instructions to cause the apparatus to perform operations including: acquiring, by invoking a first interface, environmental qubit gates associated with a two-qubit gate in the quantum processor, wherein the first interface includes a first parameter, a parameter value of the first parameter involves the two-qubit gate and the environmental qubit gates, wherein the two-qubit gate interacts with the environmental qubit gates in the quantum processor; determining a fidelity error of the environmental qubit gates based on a fidelity error of the two-qubit gate; determining frequency of the environmental qubit gates based on the fidelity error of the environmental qubit gates; determining fidelity of the two-qubit gate based on the frequency of the environmental qubit gates; and outputting, by invoking a second interface, the fidelity of the two-qubit gate, wherein the second interface includes a second parameter, and a parameter value of the second parameter represents the fidelity of the two-qubit gate.

According to some embodiments of this disclosure, an apparatus is provided for determining fidelity of a qubit gate in a quantum processor. The apparatus includes: a memory storing instructions; and one or more processors configured to execute the instructions to cause the apparatus to perform operations including: acquiring, from a quantum platform, environmental qubit gates associated with a two-qubit gate in the quantum processor, wherein the two-qubit gate interacts with the environmental qubit gates in the quantum processor; determining a fidelity error of the environmental qubit gates based on a fidelity error of the two-qubit gate; determining frequency of the environmental qubit gates based on the fidelity error of the environmental qubit gates; determining fidelity of the two-qubit gate based on the frequency of the environmental qubit gates; and returning the fidelity of the two-qubit gate to the quantum platform.

According to some embodiments of this disclosure, a computer-readable storage medium is provided and includes a set of instructions that are executable by one or more processors of a device to cause the device to perform operations for determining fidelity of a qubit gate in a quantum chip, the operations including: determining environmental qubit gates associated with a two-qubit gate in the quantum processor, wherein the two-qubit gate interacts with the environmental qubit gates in the quantum processor; determining a fidelity error of the environmental qubit gates based on a fidelity error of the two-qubit gate; determining frequency of the environmental qubit gates based on the fidelity error of the environmental qubit gates; and determining fidelity of the two-qubit gate based on the frequency of the environmental qubit gates.

According to some embodiments of this disclosure, a processor is provided. The processor is configured to run programs. The programs, when run, perform any above method for determining fidelity of a qubit gate in a quantum processor.

It is easily noted that the above general description, as well as the following detailed description are merely for the purpose of illustrating and explaining the present disclosure, but do not constitute any limitation to the present disclosure.

### BRIEF DESCRIPTION OF THE DRAWINGS

The accompanying drawings described herein are used for providing a further

understanding of the present disclosure, and forming a part of the present disclosure. Exemplary examples of the present disclosure and descriptions thereof are used for explaining the present disclosure, but do not constitute any inappropriate limitation to the present disclosure. In the accompanying drawings:

FIG. 1 is a block diagram of a hardware structure of an example computer terminal (or mobile device) for implementing a method for determining fidelity of a qubit gate in a quantum processor, according to some embodiments of the present disclosure.

FIG. 2 is a structural block diagram of an example computing environment according to some embodiments of the present disclosure.

FIG. 3 is a structural block diagram of an example service mesh according to some embodiments of the present disclosure.

FIG. 4 is a flowchart of an example method for determining fidelity of a qubit gate in a quantum processor according to some embodiments of the present disclosure.

FIG. 5 is a flowchart of an example method for determining fidelity of a qubit gate in a quantum processor according to some embodiments of the present disclosure.

FIG. 6 is a schematic diagram illustrating an example computer device accessing a private network according to some embodiments of the present disclosure.

FIG. 7 is a flowchart of an example method for determining fidelity of a qubit gate in a quantum processor according to some embodiments of the present disclosure.

FIG. 8 is a schematic diagram of frequency selection of qubits and couplers according to some embodiments of the present disclosure.

FIG. 9 is a schematic diagram of fidelity of a 15-qubit model (15 Q model) according to some embodiments of the present disclosure.

FIG. 10 is a schematic diagram of a maximum value enlarging result according to some embodiments of the present disclosure.

FIG. 11A is a schematic diagram of an evolution result according to some embodiments of the present disclosure.

FIG. 11B is a schematic diagram of another evolution result according to some embodiments of the present disclosure.

FIG. 12A is a schematic diagram of another evolution result according to some embodiments of the present disclosure.

FIG. 12B is a schematic diagram of another evolution result according to some embodiments of the present disclosure.

FIG. 13 is a schematic diagram of leakage information of an evolution result according to some embodiments of the present disclosure.

FIG. 14 is a schematic diagram of a difference of phase modulation according to some embodiments of the present disclosure.

FIG. 15 is a schematic diagram of an example apparatus for determining fidelity of a qubit gate in a quantum chip according to some embodiments of the present disclosure.

FIG. 16 is a schematic diagram of an example apparatus for determining fidelity of a qubit gate in a quantum chip according to some embodiments of the present disclosure.

FIG. 17 is a schematic diagram of an example apparatus for determining fidelity of a qubit gate in a quantum chip according to some embodiments of the present disclosure.

FIG. 18 is a structural block diagram of an example computer terminal according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms or definitions incorporated by reference.

As stated above, there is no existing technology available to characterize the fidelity of the two-qubit gates in a multi-bit environment. Embodiments of the present disclosure overcome this issue.

For example, the quantum chip's the environmental qubit gates linked to the two-qubit gate are determined, where the two-qubit gate interacts with the environmental qubit gates in the quantum processor. The fidelity error of the environmental qubit gates is determined based on the fidelity error of the two-qubit gate. The frequency of the environmental qubit gates is determined based on the fidelity error of the environmental qubit gates; and the fidelity of the two-qubit gate is determined based on the frequency of the environmental qubit gates.

Put simply, this disclosure takes into account the influence on the two-qubit gate from the environmental qubit gates associated with the two-qubit gate in the quantum processor. The fidelity is redefined, the fidelity error of the two-qubit gate is decomposed into different environmental qubit gates, and guidance is provided for selecting the frequency of the environmental qubit gates, thereby determining the fidelity satisfying conditions. This achieves the technical effect of improving the accuracy of determining the fidelity of the two-qubit gate, thereby solving the technical problem of being unable to determine its fidelity.

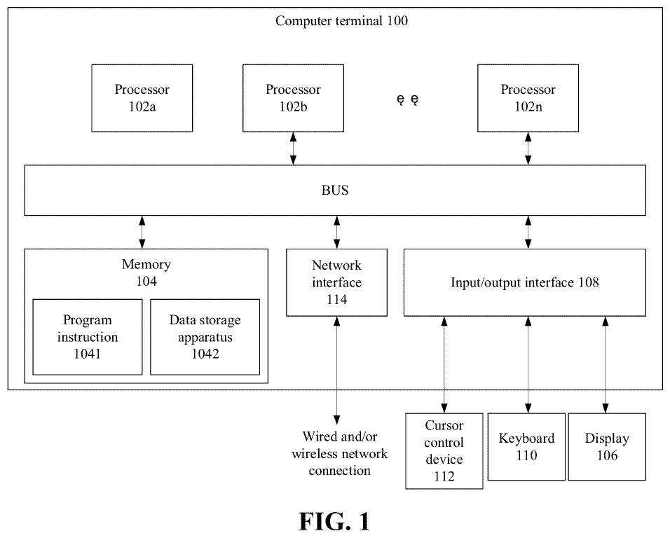

The example method provided by some embodiments of the present disclosure may be implemented in a mobile terminal, a computer terminal or similar computing devices. FIG. 1 is a block diagram of a hardware structure of an example computer terminal (or mobile device) using a method for determining fidelity of a qubit gate in a quantum processor, according to some embodiments of the present disclosure. In the present disclosure, fidelity may be used for representing the degree of similarity of reproduced input signals outputted by an electronic device. It is to be noted that, steps shown in flowcharts of the drawings may be performed in a computer system with a set of computer executable instructions. In addition, although logical sequences are shown in the flowcharts, in some cases, the steps illustrated or described may be performed in a different order than presented here.

As shown in FIG. 1, computer terminal 100 (or mobile device) may include one or more processors (shown in the figure as 102a, 102b . . . 102n, and the processors may include but be not limited to processing apparatuses such as a microprocessor MCU or a programmable logic device FPGA), a memory 104 configured to store data, and a transmission apparatus configured to perform a communication function. In addition, computer terminal 100 may further include a display 106, an input/output interface (I/O interface) 108, a keyboard 110, a cursor control device 112, a universal serial bus (USB) port (which may be included as one of the ports of a BUS), a network interface 114, a power supply or a camera. It is appreciated that the structure shown in FIG. 1 is only a schematic diagram and does not cause limitation to the structure of the electronic apparatus. For example, the computer terminal 100 may further include more or less components than those shown in FIG. 1, or has different configurations from those shown in FIG. 1.

It is be noted that the one or more processors or other data processing circuits may be generally called as a “data processing circuit” in this text. The data processing circuit may be completely or partially embodied as software, hardware, firmware or any other combination. In addition, the data processing circuit may be a single independent processing module or be completely or partially combined into any one of other elements in the computer terminal 100 (or mobile device). As involved in the embodiments of the present disclosure, the data processing circuit serves as a processor control (such as selection of a variable resistance terminal path connected with the interface).

Memory 104 can be configured to store software programs of application software and modules, such as a program instruction 1041/data storage apparatus 1042 corresponding to the qubit processing method according to the embodiments of the present disclosure; and the processor executes various function applications and data processing by running the software programs and the modules stored in memory 104, namely, a qubit processing method for the application programs is realized. Memory 104 can include a high-speed random access memory and can also include a nonvolatile memory, such as one or more magnetic storage apparatuses, flash memories or other nonvolatile solid-state memories. In some embodiments, memory 104 can further include memories remotely arranged relative to the processor, and the remote memories may be connected to computer terminal 100 through a network. The examples of the network include but are not limited to the Internet, an intranet, a local area network, a mobile communication network and a combination thereof.

The transmission apparatus is configured to receive or transmit data through a network. The specific examples of the network can include a wireless network provided by a communication provider of computer terminal 100. In one example, the transmission apparatus includes a network interface controller (NIC), and the network interface controller can be connected with other network devices through a base station so as to communicate with the internet. In one example, the transmission apparatus may be a radio frequency (RF) module and is configured to communicate with the internet in a wireless mode.

Display 106 may be a touch screen type liquid crystal display (LCD) for example, and the liquid crystal display enables a user to interact with a user interface of computer terminal 100 (or mobile device).

It is to be noted that in some alternative embodiments, the computer device (or mobile device) shown in FIG. 1 may include a hardware element (including a circuit), a software element (including computer codes stored on the computer readable medium) or a combination of the hardware element and the software element.

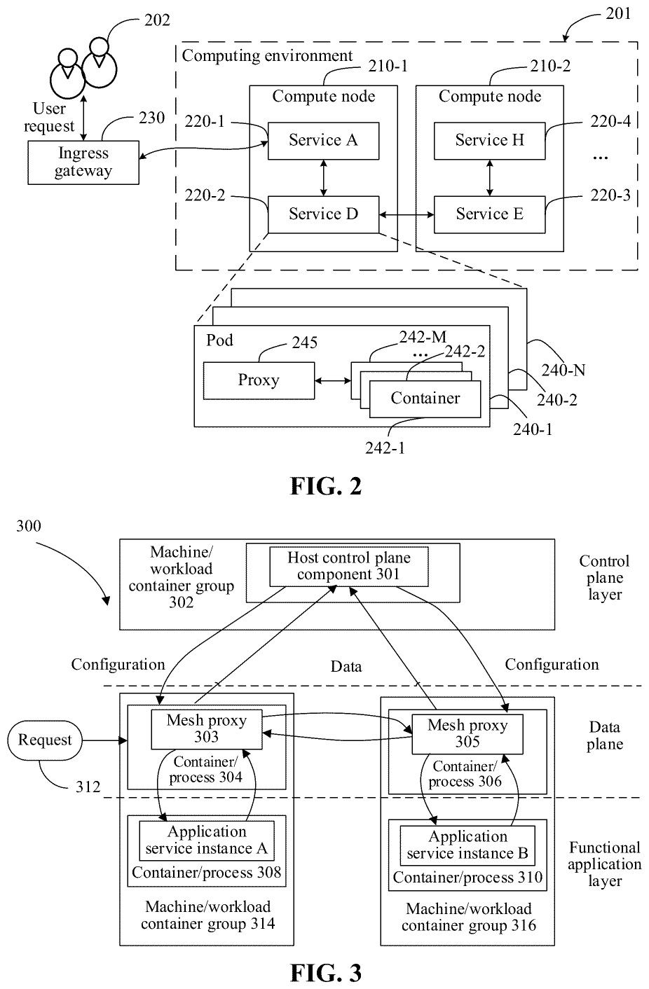

The block diagram of the hardware structure shown in FIG. 1 may serve as an illustrative block diagram not only for the aforementioned computer terminal 100 (or mobile device) but also for the aforementioned server. In some embodiments, FIG. 2 illustrates, in a block diagram form, an example of using the computer terminal 100 (or mobile device) shown in FIG. 1 as a compute node in a computing environment 201. FIG. 2 is a structural block diagram of an example computing environment according to some embodiments of the present disclosure. As shown in FIG. 2, the computing environment 201 includes a plurality of compute nodes (such as the server) running on a distributed network, as illustrated by 210-1, 210-2 . . . in the figure. Each compute node includes local processing and memory resources, allowing end users 202 to remotely run applications or store data in the computing environment 201. The applications may be provided as multiple services 220-1, 220-2, 220-3, and 220-4 in the computing environment 201, representing services “A,” “D,” “E,” and “H” respectively. The end users 202 may provide and access services through a web browser or other software applications on a client side. For example, the provisioning or requests of the end users 202 may be routed to an ingress gateway 230. The ingress gateway 230 may include a corresponding proxy to handle the provisioning or requests for services (one or more services provided in the computing environment 201).

The services are provided or deployed based on various virtualization technologies supported by the computing environment 201. For example, the services can be provided according to virtual machine (VM)-based virtualization, container-based virtualization, or similar approaches. The VM-based virtualization may involve simulating real computers by initializing the virtual machine, allowing programs and applications to run without direct access to any physical hardware resources. While a virtual machine virtualizes machines with VM-based virtualization, the container-based virtualization allows the virtualization of an entire operating systems (OS) by launching containers, which enables multiple workloads to run on a single example of the operating system.

In some embodiments of the container-based virtualization, several containers of the services may be assembled into a Pod (e.g., Kubernetes Pod). For example, as shown in FIG. 2, the service 220-2 may be equipped with one or more Pods 240-1, 240-2, . . . , and 240-N (collectively referred to as Pods). Each Pod may include a proxy 245 and one or more containers 242-1, 242-2, . . . , and 242-M (collectively referred to as containers). One or more containers within the Pod handle requests related to one or more corresponding functions of the service. The proxy 245 typically controls network functions associated with the service, such as routing and load balancing. Other services may also be equipped with Pods similar to the mentioned Pod.

In the operation process, executing user requests from the end users 202 may require invoking one or more services in the computing environment 201. Performing one or more functions of a service may require invoking one or more functions of another service. As shown in FIG. 2, the service “A” 220-1 receives the user requests from the end users 202 via the ingress gateway 230. The service “A” 220-1 can invoke the service “D” 220-2, which in turn can request the service “E” 220-3 to perform one or more functions.

The above computing environment may be a cloud computing environment, and

resource allocation is managed by cloud service providers, which allows for the development of functions without considering server implementation, adjustment, or scalability. The computing environment allows developers to execute code in response to events without building or maintaining complex infrastructure. The services may be divided into a set of functions that can scale independently and automatically, rather than scaling a single hardware device to handle potential loads.

In some embodiments, FIG. 3 illustrates, in a block diagram, an example of using the computer terminal 100 (or mobile device) shown in FIG. 1 as a service mesh. FIG. 3 is a structural block diagram of an example service mesh according to some embodiments of the present disclosure. As shown in FIG. 3, the service mesh 300 is mainly configured to facilitate secure and reliable communication between multiple microservices. The microservices refer to breaking down an application into smaller services or examples that are distributed on different clusters/machines to run.

As shown in FIG. 3, the microservices may include an application service instance A and an application service instance B, which form a functional application layer of the service mesh 300. In some embodiments, the application service instance A runs in the form of a container/process 308 within a machine/workload container group 314 (Pod). The application service instance B runs in the form of a container/process 310 within a machine/workload container group 316 (Pod).

In some embodiments, the application service instance A may be a product query service. The application service instance B may be a product ordering service.

As shown in FIG. 3, the application service instance A and a mesh proxy (sidecar) 303 coexist within the machine/workload container group 614. The application service instance B and a mesh proxy 305 coexist within the machine/workload container group 314. The mesh proxy 303 and the mesh proxy 305 form a data plane of the service mesh 300. The mesh proxy 303 and the mesh proxy 305 run as the container/process 304 and the container/process 306, and can receive a request 312 for performing the product query service. The mesh proxy 303 and the application service instance A can be in bidirectional communication, and the mesh proxy 305 and the application service instance B can also be in bidirectional communication. In addition, the mesh proxy 303 and the mesh proxy 305 may also be in bidirectional communication.

In some embodiments, all traffic from the application service instance A is routed to an appropriate destination through the mesh proxy 303. All network traffic from the application service instance B is routed to an appropriate destination through the mesh proxy 305. It is to be noted that, the mentioned network traffic includes, but is not limited to, forms such as a hypertext transfer protocol (HTTP) and a representational state transfer (REST), characterized by high performance.

In some embodiments, the function of the data plane is expanded by writing a custom filter for the proxy (Envoy) in the service mesh 300. The configuration of service mesh proxy is to ensure correct proxy of service traffic by the service mesh, and achieve service communication and governance. The mesh proxy 303 and the mesh proxy 305 may be configured to perform at least one of the following functions: service discovery, health checking, routing, load balancing, authentication and authorization, and observability.

As shown in FIG. 3, the service mesh 300 may further include a control plane layer. The control plane layer may include a set of services running in a dedicated namespace, hosted by a host control plane component 301 within the machine/workload container group (machine/Pod) 302. As shown in FIG. 3, the host control plane component 301 is in bidirectional communication with the mesh proxy 303 and the mesh proxy 305. The host control plane component 301 is configured to perform some control and management functions. For example, the host control plane component 301 receives telemetry data transmitted by the mesh proxy 303 and the mesh proxy 305, and can further aggregate the telemetry data. Due to the services, the host control plane component 301 can also provide a user-facing application programming interface (API), thereby facilitating easy manipulation of network behaviors and supplying configuration data to the mesh proxy 303 and the mesh proxy 305.

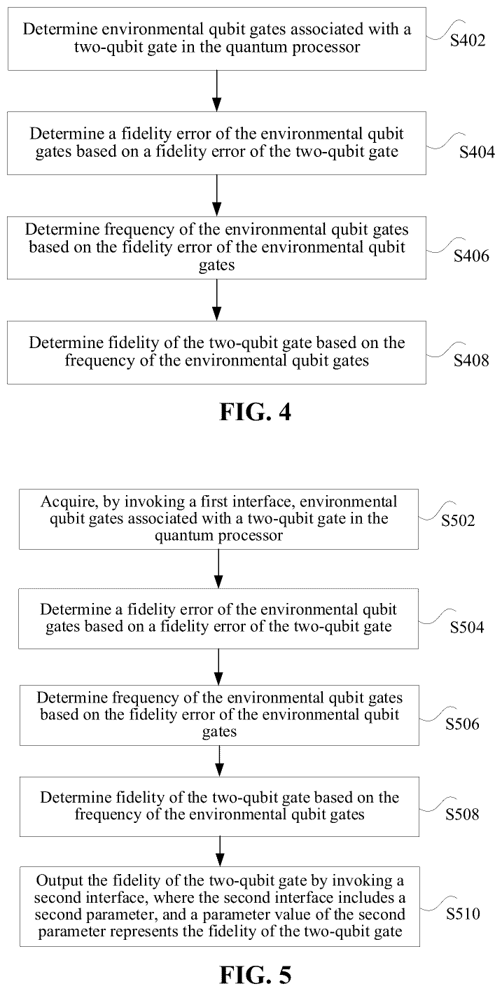

FIG. 4 is a flowchart of an example method for determining fidelity of a qubit gate in a quantum processor according to some embodiments of the present disclosure. It is to be noted that steps shown in flowcharts of the accompanying drawings may be performed in a computer system with a set of computer executable instructions. In addition, although logical sequences are shown in the flowcharts, in some cases, the steps illustrated or described may be performed in a different order than presented here.

As shown in FIG. 4, the method may include the following steps S402-S408.

In step S402, the computer system determines environmental qubit gates associated with a two-qubit gate in the quantum processor, where the two-qubit gate interacts with the environmental qubit gates in the quantum processor.

In step S402 of the present disclosure, the environmental qubit gates associated with the two-qubit gate in the quantum processor can be determined, and the two-qubit gate interacts with the environmental qubit gates in the quantum processor. The environmental qubit gates may include environmental quantum bits surrounding the two-qubit gate, which may be a quantum gate for one environmental qubit or for two or more environmental qubits. The environmental qubit gates are not specifically limited herein.

In some embodiments, in the quantum processor, the control effect of the two-qubit gate can be influenced by the surrounding quantum bits. The quantum bits influencing the two-qubit gate around the two-qubit gate can be determined, thereby determining the environmental qubit gates associated with the two-qubit gate in the quantum processor.

In step S404, the computer system determines a fidelity error of the environmental qubit gates based on a fidelity error of the two-qubit gate.

In step S404 of the present disclosure, the fidelity error of the two-qubit gate is determined, and then the fidelity error of the environmental qubit gates can be determined based on the fidelity error of the two-qubit gate. The fidelity error of the two-qubit gate may be an overall error of the quantum processor.

In some embodiments, the fidelity error of the two-qubit gate is determined and can be decomposed into different environmental qubit gates, and by determining the fidelity error decomposed into each environmental qubit gate, the fidelity error of the environmental qubit gates is obtained.

In step S406, the computer system determines frequency of the environmental qubit gates based on the fidelity error of the environmental qubit gates.

In step S406 of the present disclosure, the frequency of the environmental qubit gates can be determined based on the fidelity error of the environmental qubit gates.

As described above, by decomposing the overall error into different environmental qubit gates, and based on the fidelity error allocated to each environmental qubit gate, selecting the frequency of the environmental qubit gates is guided.

In step S408, the computer system determines fidelity of the two-qubit gate based on the frequency of the environmental qubit gates.

In step S408 of the present disclosure, the frequency of the environmental qubit gates can be acquired, and based on the frequency of the environmental qubit gates, the fidelity of the two-qubit gate can be determined.

For example, a corresponding relationship between the fidelity of the environmental qubit gates and the fidelity of the two-qubit gate can be pre-acquired, thereby determining the fidelity of the two-qubit gate based on the frequency of the environmental qubit gates.

According to steps S402 to S408 in the present disclosure, the environmental qubit gates associated with the two-qubit gate in the quantum processor are determined, where the two-qubit gate interacts with the environmental qubit gates in the quantum processor; the fidelity error of the environmental qubit gates is determined based on the fidelity error of the two-qubit gate; the frequency of the environmental qubit gates is determined based on the fidelity error of the environmental qubit gates; and the fidelity of the two-qubit gate is determined based on the frequency of the environmental qubit gates. In other words, in some embodiments of the present disclosure, the influence on the two-qubit gate from the environmental qubit gates associated with the two-qubit gate in the quantum processor is considered. The fidelity is redefined, the fidelity error of the two-qubit gate is decomposed into different environmental qubit gates, and guidance is provided for selecting the frequency of the environmental qubit gates, thereby determining the fidelity satisfying conditions, achieving the technical effect of improving the accuracy of determining the fidelity of the two-qubit gate, and solving the technical problem of being unable to determine the fidelity of the two-qubit gate.

In some embodiments, step S404 of determining a fidelity error of the environmental qubit gates based on a fidelity error of the two-qubit gate includes: the fidelity error of the two-qubit gate can be decomposed into different environmental qubit gates, thereby obtaining the fidelity error of the different environmental qubit gates.

As described above, the fidelity error of the two-qubit gate can be determined, and by decomposing the fidelity error into different environmental qubit gates, the fidelity error of the different environmental qubit gates is obtained.

In some embodiments, step S406 of determining frequency of the environmental qubit gates based on the fidelity error of the environmental qubit gates includes: scanning a superconducting circuit of the quantum processor to obtain multiple parameters; and determining the frequency of the environmental qubit gates corresponding to the fidelity error of the environmental qubit gates based on the multiple parameters.

In some embodiments, the superconducting circuit of the quantum processor is scanned to determine the multiple parameters in the superconducting circuit, and the frequency of the environmental qubit gates corresponding to the fidelity error of the environmental qubit gates can be determined based on the multiple parameters. The parameters may include single-qubit parameters, a number of single-qubits in a multi-qubit model, local extremum offsets, etc. The mentioned content herein is only as an illustrative example, without specific limitations on the parameters.

In some embodiments, the superconducting circuit can be scanned to determine the multiple parameters in the superconducting circuit, and the frequency of the environmental qubit gates corresponding to the fidelity error of the environmental qubit gates can be determined based on the multiple parameters.

In some embodiments, the multiple parameters include the single-qubit parameters, and the step of determining the frequency of the environmental qubit gates corresponding to the fidelity error of the environmental qubit gates based on the multiple parameters includes: determining the frequency of the environmental qubit gates and frequency of a coupler corresponding to the fidelity error of the environmental qubit gates based on the single-qubit parameters. The step of determining fidelity of the two-qubit gate based on the frequency of the environmental qubit gates includes: determining the fidelity of the two-qubit gate based on the frequency of the environmental qubit gates and the frequency of the coupler.

In the present disclosure, a coupler may be a radio frequency device that can extract a small part of signals from a wireless signal backbone channel.

In some embodiments, the superconducting circuit may include at least one single-qubit quantum, and the single-qubit parameters in the superconducting circuit can be determined. The single-qubit parameters may include single-qubit frequency, such as the frequency of environmental qubits in the environmental qubit gates and the frequency of the two-qubit gate. The mentioned content herein is only as an illustrative example for the qubit parameters, without specific limitations. The fidelity of the two-qubit gate can be determined based on the frequency of the environmental qubit gates and the frequency of the coupler.

For example, the fidelity error of the two-qubit gate can be determined and allocated to the environmental qubit gates. The frequency of the environmental qubit gates and the frequency of the coupler corresponding to the fidelity error of the environmental qubit gates can be determined based on the single-qubit parameters. For example, the frequency of the environmental qubit gates may be 2, −3, etc., and the frequency of the coupler may be 0, −1, etc. It is to be noted that, the numbers are only for an illustrative purpose, without specifically limiting the frequency. The fidelity of the two-qubit gate can be determined based on the frequency of the environmental qubit gates and the frequency of the coupler.

In some embodiments, in order to suppress inter-qubit resonance, some embodiments of the present disclosure selects a minimal frequency range for the environmental qubit gates and the coupler. When the frequency difference between any two identical qubits is less than 50 MHz, the resonance phenomenon between the qubits is prominent and has an adverse impact on gate operations. Therefore, some embodiments of the present disclosure sets the frequency difference between the adjacent environmental qubit gate and coupler to be greater than 50 MHz.

In some embodiments, the multiple parameters include a number of single-qubit states in a multi-qubit model, and the step of determining the frequency of the environmental qubit gates corresponding to the fidelity error of the environmental qubit gates based on the multiple parameters includes: determining the frequency of the environmental qubit gates and the frequency of the coupler corresponding to the fidelity error of the environmental qubit gates based on the number of the single-qubit states in the multi-qubit model. The step of determining fidelity of the two-qubit gate based on the frequency of the environmental qubit gates includes: determining the fidelity corresponding to the frequency of the environmental qubit gates and the frequency of the coupler as the fidelity of the two-qubit gate. In the present disclosure, a state may also be referred to as a phase.

As described above, the multiple parameters may include a number of single-qubit states in a multi-qubit model. The number of the single-qubit states in the multi-qubit model is determined. The frequency of the environmental qubit gates and the frequency of the coupler corresponding to the fidelity error of the environmental qubit gates are determined based on the number of the single-qubit states in the multi-qubit model. The fidelity corresponding to the frequency of the environmental qubit gates and the frequency of the coupler is determined as the fidelity of the two-qubit gate. The environmental qubit gates may contain environmental qubits, and the coupler may include an environmental coupler.

In some embodiments, considering that in the multi-qubit model, the greater the number of the single-qubit states, the smaller the time interval values, and the longer the runtime. The number of the single-qubit states in the multi-qubit model is determined. Based on the number of the single-qubit states in the multi-qubit model, the frequency of the environmental qubit gates and the frequency of the coupler corresponding to the fidelity error of the environmental qubit gates are determined within an acceptable accuracy range, and the fidelity corresponding to the frequency of the environmental qubit gates and the frequency of the coupler is determined as the fidelity of the two-qubit gate.

For example, the single-qubit state of the multi-qubit model may be pre-defined as a 3-qubit (Q) model state. Based on a reference table for selecting 3-qubit (Q) model state parameters, the frequency of the environmental qubit gates and the frequency of the coupler corresponding to the fidelity error of the environmental qubit gates are determined based on the number of the single-qubit states in the multi-qubit model, and the fidelity corresponding to the frequency of the environmental qubit gates and the frequency of the coupler is determined as the fidelity of the two-qubit gate. If the frequency of the environmental qubit gates is determined as 3, and the frequency of the coupler is determined as 8 in the parameter selecting reference table, because the fidelity corresponding to the frequency of the environmental qubit gates and the frequency of the coupler in the parameter selecting reference table is 0.998531, the fidelity of the two-qubit gate can be determined as 0.998531. The above numbers are only used for illustrative purposes, without specific limitations.

In some embodiments, the multiple parameters include an offset local extremum, and the step of determining the frequency of the environmental qubit gates corresponding to the fidelity error of the environmental qubit gates based on the multiple parameters includes: determining a real local extremum based on the offset local extremum; and determining the frequency of the environmental qubit gates corresponding to the fidelity error of the environmental qubit gates based on the real local extremum. The step of determining fidelity of the two-qubit gate based on the frequency of the environmental qubit gates includes: determining the fidelity corresponding to the frequency of the environmental qubit gates as the fidelity of the two-qubit gate.

As described above, the multiple parameters may include the offset local extremum. The real local extremum may be determined based on the offset local extremum. The frequency of the environmental qubit gates corresponding to the fidelity error of the environmental qubit gates can be determined based on the real local extremum. The fidelity corresponding to the frequency of the environmental qubit gates can be determined as the fidelity of the two-qubit gate. The offset local extremum may include a maximum value point, which may be an unreal extremum point located on the boundary, such as (0.423, 45, 0.921256). The real local extremum may be a real extremum point determined after range expanding, such as (0.413, 66, 0.9910813). It is to be noted that, the above numbers are only for an illustrative purpose, without specifically limiting the values of the numbers.

For example, an offset local extremum of a B-type superconducting circuit is determined, and maximum values in the offset local extremum and bad points with fidelity much lower than the fidelity of surrounding points are obtained. There are two maximum value points (0.426, 35, 0.890727) and (0.423, 45, 0.921256) within the range of the offset local extremum. Due to the significant offsets of the pre-determined extremum points of this type of superconducting circuit, the extremum points within the offset local extremum may not represent the real local extremum and may be only unreal extremum points located on the boundary, the real local extremum may be determined based on the maximum value point (0.423, 45, 0.921256), and the real local extremum (0.413, 66, 0.9910813) can be found after range expanding. Based on the real local extremum, the frequency of the environmental qubit gates corresponding to the fidelity error of the environmental qubit gates can be determined, and the fidelity corresponding to the frequency of the environmental qubit gates can be determined as the fidelity of the two-qubit gate.

In some embodiments, the multiple parameters include the basis vector, and the step of determining the frequency of the environmental qubit gates corresponding to the fidelity error of the environmental qubit gates based on the multiple parameters includes: determining an evolution result of the quantum processor in the basis vector; and determining the frequency of the environmental qubit gates corresponding to the fidelity error of the environmental qubit gates based on the evolution result, where a magnitude of the fidelity error of the environmental qubit gates is less than a magnitude threshold. In the present disclosure, a basis vector is a terminology in the field of semiconductor physics, which is used for representing a vector determining the size of a unit cell.

As described above, the multiple parameters include the basis vector, where the basis vector may include a product basis vector, an open source library basis vector (eigen basis vector), etc. The mentioned content herein is only as an illustrative example, without specifically limiting the type of basis vectors. The evolution result of the quantum processor in the basis vector can be determined, and based on the evolution result, the frequency of the environmental qubit gates corresponding to the fidelity error of the environmental qubit gates can be determined, where a magnitude of the fidelity error of the environmental qubit gates may be less than the magnitude threshold, such as 0.001. The evolution result may include an evolution result in the product basis vector, an evolution result in the eigen basis vector, etc. The mentioned content herein is only as an illustrative example, without specifically limiting the evolution result.

The evolution results in the product basis vector and the eigen basis vector are determined. When a text string (phiext) and a gate operation parameter (time gate) are changed, the selection of the basis vector does not have a significant influence on the fidelity change trend, with the error being at the magnitude of 0.001. If actual measurement is performed in the eigen basis, the evolution result may be the evolution result in the eigen basis vector. The mentioned content herein is only as an illustrative example, without specifically limiting the selection of the basis vector in some embodiments of the present disclosure.

For example, the evolution result of the superconducting circuit in the basis vector may be determined, and the evolution results in the product basis vector, the eigen basis vector, etc. may be obtained. Based on the evolution results, the frequency of the environmental qubit gates corresponding to the fidelity error of the environmental qubit gates can be determined, and the fidelity of the two-qubit gate can be determined based on the frequency of the environmental qubit gates.

For another example, transformation matrices u_b3q_to_b3 and u_b7q_to_b7 between the product basis vector and the eigen basis vector can be provided in advance for the multi-qubit type. The transformation matrix may be denoted by U. For any matrix A, a basis vector transformation operation can be based on the following the following formula:

A_{EIGEN}=U^{†}A_{PRODUCT}U

where A_{EIGEN} may denote a matrix obtained after basis vector transformation, U^{†}may denote a conjugate transpose matrix of the transformation matrix, and A_{PRODUCT} may denote a matrix in the product basis vector. Due to the process of time evolution (trotter), the interaction between two qubits cannot be decomposed in the eigen basis vector into a simple direct product form of single-qubit states. Therefore, it is necessary to transform from the eigen basis vector to the product basis vector for the time evolution. For example, if the initial state is denoted by |φ [symbol] , the final state can be denoted based on:

|φ′ [symbol] _{EIGEN}=U_{EIGEN}(t)|φ [symbol] _{EIGEN}=U^{†}U_{PRODUCT}(t)U|φ [symbol] _{EIGEN}

The above may be implemented in the program as follows: the initial state in the eigen basis vector is set as |φ [symbol] _{EIGEN}, and is transformed by the transformation matrix U into the product basis vector U|φ [symbol] _{EIGEN}, time evolution U_{PRODUCT}U|φ [symbol] _{EIGEN} is performed by the trotter process, and finally a result is transformed back to the eigen basis vector U^{†}U_{PRODUCT}U|φ [symbol] _{EIGEN} to obtain the evolution result in the eigen basis vector.

It is to be noted that, due to the lack of a sorting operation on u_b*t_to_b*, during eigen-product space transformation, u_b*q_to_b* in the multi-qubit type may be used instead of u_b*t_to_b*, thereby improving the efficiency and accuracy of the transformation.

In some embodiments, multiple parameters include waveform parameters, and the waveform parameters are maximum value points determined based on an evolution result. The step of determining the frequency of the environmental qubit gates corresponding to the fidelity error of the environmental qubit gates based on the multiple parameters includes: determining the frequency of the environmental qubit gates corresponding to the fidelity error of the environmental qubit gates based on the waveform parameters.

As described above, the multiple parameters may include the waveform parameters. The waveform parameters may be the maximum value points determined based on the evolution result. The frequency of the environmental qubit gates corresponding to the fidelity error of the environmental qubit gates may be determined based on the waveform parameters, and the fidelity of the two-qubit gate may be determined based on the frequency of the environmental qubit gates.

For example, according to the evolution result in the eigen basis vector, t denotes the local maximum value point 33. Two local maximum values are found from a wide range of a two-dimensional variable (sigma-phiext), which may be determined according to a pre-experimental result. The appropriate waveform parameters may be selected from parameters satisfying conditions without considering the environmental qubits, that is, the maximum value points nearby sigma=7. It is to be noted that the above numbers are only for an illustrative purpose, without specific limitations.

In some embodiments, multiple parameters include a local maximum value of an evolution result. The step of determining the frequency of the environmental qubit gates corresponding to the fidelity error of the environmental qubit gates based on the multiple parameters includes: determining leakage information of the quantum processor at the local maximum value; and determining a qubit state to which the environmental qubit gates corresponding to the leakage information transition jumps, and determining the frequency of the environmental qubit gates corresponding to the fidelity error of the environmental qubit gates in the qubit state. The step of determining fidelity of the two-qubit gate based on the frequency of the environmental qubit gates includes: the fidelity corresponding to the frequency of the environmental qubit gates is determined as the fidelity of the two-qubit gate.

As described above, the multiple parameters include the local maximum value in the evolution result. The leakage information of the quantum processor at the local maximum value can be determined. The qubit state to which the environmental qubit gates corresponding to the leakage information transition jumps can be determined. The frequency of the environmental qubit gates corresponding to the fidelity error of the environmental qubit gates in the qubit state is determined. The fidelity corresponding to the frequency of the environmental qubit gates can be determined as the fidelity of the two-qubit gate. The local maximum value may be used for representing the maximum fidelity, such as (0.426, 7.0, 0.609772). The leakage information (or simplified as leakage) may be used for representing the information that causes fidelity errors.

For example, an evolution result of a 7 Q model in the eigen basis vector can be determined, and the local maximum value (0.426, 7.0, 0.909772) is determined according to the evolution result. Moreover, the leakage information of the evolution result is determined, thereby obtaining the maximum value (0.424, 5.4, 0.237816) and the minimum value (0.428, 8.6, 0.165885) in the leakage information. A difference between phase modulation (CZphase) and π (or −π) in the evolution result is determined with the unit being π. The upper left region of the evolution result is represented by positive values (close to π), and the lower right region is represented by negative values (close to −π). The maximum value and the minimum value in the positive region in the leakage region are determined as (0.994814, 0.735788), and the maximum value and the minimum value in the negative region are determined as (−0.768197, −0.999719). The leakage information at the maximum value (0.426, 7.0, 0.909772) is analyzed to obtain czphase=0.988097 π, and leakage=0.199811. Further, the qubit state to which the environmental qubit gates corresponding to the leakage information transition jumps can be determined, a component with the maximum leakage information is determined as a second environmental qubit gate, and the second environmental qubit gate transitions to the state 1 with a significantly higher probability compared to other components. It is to be noted that the total leakage and the leakage of several qubit states are not calculated using the same algorithm, and therefore the sum of the leakage of the several qubit states is not equal to the total leakage.

In some embodiments, a computational matrix of the maximum component may be extracted, and matrix elements are observed, thereby determining that probability leakage happens at two processes |001(0000) [symbol] →|000(0001) [symbol] and |101(0000) [symbol] →|100(0001) [symbol] . Among the seven numbers, the first and third positions represent central qubit states, the second position represents a central coupler state, the fourth and sixth positions represent environmental coupler states, and the fifth and seventh positions represent environmental qubit states, thereby determining the environmental qubit states. The frequency of the environmental qubit gates corresponding to the fidelity error of the environmental qubit gates in the qubit state can be determined; and the fidelity corresponding to the frequency of the environmental qubit gates is determined as the fidelity of the two-qubit gate.

For another example, for a two-qubit gate evolution matrix U, the initial state v of any data qubit is selected, satisfying v^{†}v=1, and the final state is given by Uv. By using an optimization algorithm (e.g., a gradient descent algorithm), v is found in a parameter space to satisfy

$$L = {min}_{v} ( {v}^{†} {U}^{†} Uv ) ,$$

thereby determining the total leakage being (1−L), where L may represent the probability of a given environmental qubit leaking to a specific final state.

Meanwhile, in order to calculate the magnitude of leakage for the given environmental qubit, a leakage channel may be set, such as |00ₑ [symbol] →|01ₑ). The four final states (|00 [symbol] , |01 [symbol] , |10 [symbol] , and |11 [symbol] ) of the two-qubit gate evolution matrix will be transformed into the corresponding four final states (|00(01ₑ) [symbol] , |01(01ₑ) [symbol] , |10(01ₑ) [symbol] , and |11(01ₑ) [symbol] ), thereby extracting the four initial states (|00(00ₑ) [symbol] , |01(00ₑ) [symbol] , |10(00ₑ) [symbol] , and |11(00ₑ) [symbol] ) from the full-space evolution matrix to correspond to 16 matrix elements of new four final states (|00(01ₑ) [symbol] , |01(01ₑ) [symbol] , |10(01ₑ) [symbol] , and |11(01ₑ) [symbol] ) to form a 4*4 matrix U, and then calculate based on the following formula:

L=tr(U^{†}U)

where, the value of L may represent the probability of the given environmental qubit leaking to a specific final state. The evolution matrix may be based on the following form:

$$\begin{matrix}\vert 00 ( {00}_{e} ) 〉 \\ \vert 01 ( {00}_{e} ) 〉 \\ \vert 10 ( {00}_{e} ) 〉 \\ \vert 11 ( {00}_{e} ) 〉\end{matrix} {( \begin{matrix} & & & \\ & & & \\ & & & \\ & & & \end{matrix} )}^{\begin{matrix}\vert 00 ( {01}_{e} ) 〉 & \vert 01 ( {01}_{e} ) 〉 & \vert 10 ( {01}_{e} ) 〉 & \vert 11 ( {01}_{e} ) 〉\end{matrix}}$$

Based on the above calculation method, the probability of the given environmental qubit leaking to the specific final state can be determined, so as to determine the total leakage.

In some embodiments, in this method, the quantum processor includes inductively-coupled fluxonium-type qubits, or transmon-type qubits.

In this disclosure, fluxonium, also referred to as a flux qubit in the realm of superconducting quantum bits, serves as a primary quantum bit in magnetic flux quantum bits. It has the unique ability to connect numerous large junctions (acting as large capacitors) in series, followed by connecting these series of large junctions in parallel with small junctions. Interestingly, the entire loop lacks any small superconducting islands to prevent any influence from charge drift. The series connection of large junctions also provides a sufficiently large inductance, ensuring that quantum fluctuations in charge distribution are smaller than a Cooper pair charge. Moreover, when the system oscillation frequency is significantly lower than the plasma oscillation frequency of the large junctions, fluxonium can effectively suppress low-frequency charge drift, while preserving high-frequency oscillation components of the charge. Furthermore, when the magnetic flux in a fluxonium loop changes, the energy level structure can be tuned over a wide range, from 0.5 GHz to 10 GHz.

In the present disclosure, a transmission line shunted plasma oscillation qubit, also known as a transmon qubit, can function as a capacitive quantum bit (charge qubit) in the superconducting quantum bits. This type of qubit is often referred to as a primary quantum bit under charge quantum bits (copper-pairbox). Its purpose is to increase the ratio between Josephson energy (EJ) and charge energy (EC) to flatten the dispersion relation of system energy states with respect to gate charge. To reduce sensitivity to charge noise, a large capacitor is connected in parallel at the two ends of a Josephson junction. Additionally, a coupling capacitor between the transmon qubit and a linear resonant cavity forms a circuit quantum electrodynamics (circuit-QED) system, which enables manipulation and readout of the quantum bits. In some embodiments, the superconducting quantum chip may include the fluxonium-type qubits. The use of the fluxonium-type qubits can well suppress low-frequency charge drift while preserving high-frequency charge oscillation parts. When the flux in a fluxonium loop is changed, an energy level structure can be tuned over a wide range (0.5 GHz to 10 GHz), thereby facilitating quick adjustment of the parameters of the quantum chip when the fidelity between two-qubit gates is low.

In some embodiments, the superconducting quantum chip may include the transmon-type qubits. By use of the transmon-type qubits, manipulation and readout of the quantum bits can be realized.

In some embodiments of the present disclosure, the influence on the two-qubit gate from the environmental qubit gates associated with the two-qubit gate in the quantum processor is considered. The fidelity is redefined, the fidelity error of the two-qubit gate is decomposed into different environmental qubit gates, and guidance is provided for selecting the frequency of the environmental qubit gates, thereby determining the fidelity satisfying conditions, achieving the technical effect of improving the accuracy of determining the fidelity of the two-qubit gate, and solving the technical problem of being unable to determine the fidelity of the two-qubit gate.

FIG. 5 is a flowchart of an example method for determining fidelity of a qubit gate in a quantum processor, which may be applied to a software-as-a-service (SaaS) side, according to some embodiments of the present disclosure. It is to be noted that, steps shown in flowcharts of the accompanying drawings may be performed in a computer system with a set of computer executable instructions. In addition, although logical sequences are shown in the flowcharts, in some cases, the steps illustrated or described may be performed in a different order than presented here. As shown in FIG. 5, the method may include the following steps S502-S510.

In step S502, the computer system acquires, by invoking a first interface, environmental qubit gates associated with a two-qubit gate in the quantum processor. The first interface includes a first parameter, a parameter value of the first parameter involves the two-qubit gate and the environmental qubit gates, and the two-qubit gate interacts with the environmental qubit gates in the quantum processor.

In step S502 of this disclosure, the first interface may be an interface for data interaction between a server and a user side. The user side can invoke the first interface to obtain the environmental qubit gates associated with the two-qubit gate in the quantum processor. The two-qubit gate and the environmental qubit gates serve as the first parameter of the first interface, thereby achieving the purpose of obtaining the environmental qubit gates associated with the two-qubit gate in the quantum processor, where the two-qubit gate interacts with the environmental qubit gates in the quantum processor.

In step S504, the computer system determines a fidelity error of the environmental qubit gates based on a fidelity error of the two-qubit gate.

In step S506, the computer system determines frequency of the environmental qubit gates based on the fidelity error of the environmental qubit gates.

In step S508, the computer system determines fidelity of the two-qubit gate based on the frequency of the environmental qubit gates.

In step S510, the computer system outputs, by invoking a second interface, the fidelity of the two-qubit gate, where the second interface includes a second parameter, and a parameter value of the second parameter represents the fidelity of the two-qubit gate.

In step S510 of this disclosure, the second interface may be an interface for data interaction between the server and the user side. The server can output and send the fidelity of the two-qubit gate to a client, enabling the client to output the fidelity of the two-qubit gate to the second interface as a parameter of the second interface, thereby achieving the purpose of sending the fidelity of the two-qubit gate to the user side.

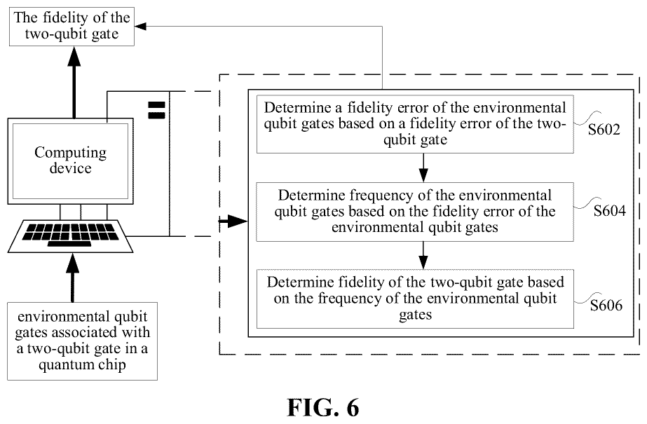

FIG. 6 is a schematic diagram illustrating an example computer device accessing a private network according to some embodiments of the present disclosure. As shown in FIG. 6, environmental qubit gates associated with a two-qubit gate in a quantum processor can be obtained by invoking a first interface, the computer device performs steps S602-S606.

In step S602, the computer device determines a fidelity error of the environmental qubit gates based on a fidelity error of the two-qubit gate.

In step S604, the computer device determines frequency of the environmental qubit gates based on the fidelity error of the environmental qubit gates.

In step S606, the computer device determines fidelity of the two-qubit gate based on the frequency of the environmental qubit gates.

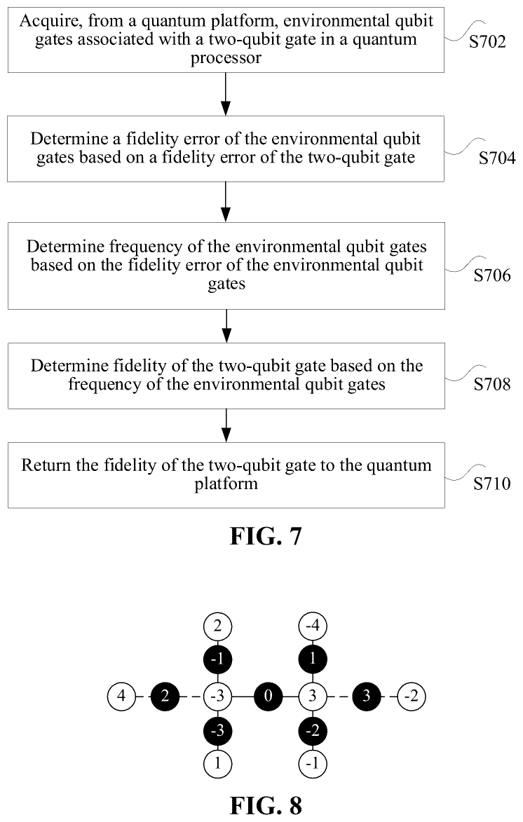

In some embodiments, a platform can output the fidelity of the two-qubit gate by invoking the second interface, where the second interface can be used for sending the fidelity of the two-qubit gate to a client, such that the client outputs the fidelity of the two-qubit gate. FIG. 7 is a flowchart of an example method for determining fidelity of a qubit gate in a quantum processor according to some embodiments of the present disclosure. It is to be noted that, steps shown in flowcharts of the accompanying drawings may be performed in a computer system with a set of computer executable instructions. In addition, although logical sequences are shown in the flowcharts, in some cases, the steps illustrated or described may be performed in a different order than presented here.

As shown in FIG. 7, the method may include the following steps S702-S710.

In step S702, a system (e.g., computer terminal 100 in FIG. 1) may acquire, from a quantum platform, environmental qubit gates associated with a two-qubit gate in the quantum processor, where the two-qubit gate interacts with the environmental qubit gates in the quantum processor.

In step S704, the system may determine a fidelity error of the environmental qubit gates based on a fidelity error of the two-qubit gate.

In step S706, the system may determine frequency of the environmental qubit gates based on the fidelity error of the environmental qubit gates.

In step S708, the system may determine fidelity of the two-qubit gate based on the frequency of the environmental qubit gates.

In step S710, the system may return the fidelity of the two-qubit gate to the quantum platform.

According to steps S702 to S710 of the present disclosure, the environmental qubit gates associated with the two-qubit gate in the quantum processor is acquired from the quantum platform, where the two-qubit gate interacts with the environmental qubit gates in the quantum processor; the fidelity error of the environmental qubit gates is determined based on the fidelity error of the two-qubit gate; the frequency of the environmental qubit gates is determined based on the fidelity error of the environmental qubit gates; the fidelity of the two-qubit gate is determined based on the frequency of the environmental qubit gates; and the fidelity of the two-qubit gate is returned to the quantum platform. The technical effect of improving the accuracy of the determined fidelity of the two-qubit gate is achieved, and the technical problem of being unable to determine the fidelity of the two-qubit gate is solved.

In the conventional design process of superconducting quantum chips, only the fidelity of an isolated two-qubit gate (quantum gate) is considered. However, in a real quantum chip, the two-qubit gate inevitably interacts with surrounding quantum bits. But there is no existing technology available to characterize the fidelity of the two-qubit gate in a multi-qubit environment.

To characterize the fidelity of the two-qubit gate in the multi-qubit environment, an example of the present disclosure provides a method for implementing adjustable inductive coupling (fluxonium) of a high-fidelity two-qubit gate in a multi-qubit environment. This method redefines the fidelity, and searches for the fidelity satisfying conditions by scanning parameters in a superconducting circuit. Selection of the frequency of the environmental qubits is guided by decomposing the overall error into the different environmental qubits.

The method for implementing adjustable inductive coupling of a high-fidelity two-qubit gate in a multi-qubit environment according to some embodiments of the present disclosure is further described below.

The superconducting circuit of the quantum processor is scanned, thereby determining multiple parameters of the superconducting circuit. Based on the multiple parameters, the frequency of the environmental qubit gates corresponding to the fidelity error of the environmental qubit gates is determined. The parameters may include single-qubit parameters, a number of single-qubits in a multi-qubit model, local extremum offsets, etc. The mentioned content herein is only as an illustrative example, without specific limitations on the parameters.

In some embodiments, the superconducting circuit can be scanned to determine the multiple parameters in the superconducting circuit, and the frequency of the environmental qubit gates corresponding to the fidelity error of the environmental qubit gates can be determined based on the multiple parameters.

In some embodiments, the fidelity error of the two-qubit gate can be determined, and can be allocated to the environmental qubit gates. Based on the single-qubit parameters, the frequency of the environmental qubit gates and frequency of a coupler corresponding to the fidelity error of the environmental qubit gates can be determined. The fidelity of the two-qubit gate can be determined based on the frequency of the environmental qubit gates and the frequency of the coupler. FIG. 8 is a schematic diagram of frequency selection of qubits and couplers according to some embodiments of the present disclosure. As shown in FIG. 8, the black represents the couplers, and the white represents the data qubits. The numerical values within the couplers and qubits represent the selected frequencies, with a difference of 1 indicating a frequency difference greater than 50 MHz. The frequencies of the data qubits can be determined as 4, −3, 3, −2, −4, 1, −1, etc. The frequencies of the couplers can be determined as 1, -1, 2, −2, 3, −3, etc.

In some embodiments, in order to suppress inter-qubit resonance, some embodiments of the present disclosure selects a minimal frequency range for the environmental qubit gates and the coupler. When the frequency difference between any two identical qubits is less than 50 MHz, the resonance phenomenon between the qubits is prominent and has an adverse impact on gate operations. Therefore, some embodiments of the present disclosure sets the frequency difference between the adjacent environmental qubit gate and coupler to be greater than 50 MHz.

In some embodiments, considering that in the multi-qubit model, the greater the number of the single-qubit states, the smaller the time interval values, and the longer the runtime. The number of the single-qubit states in the multi-qubit model is determined. Based on the number of the single-qubit states in the multi-qubit model, the frequency of the environmental qubit gates and the frequency of the coupler corresponding to the fidelity error of the environmental qubit gates are determined within an acceptable accuracy range, and the fidelity corresponding to the frequency of the environmental qubit gates and the frequency of the coupler is determined as the fidelity of the two-qubit gate.

For example, a reference table for selection of model state parameters can be pre-determined. Multiple processing manners may be used, such as an Adams method (sesolve). Table 1 represents 3-qubit model state parameter reference data. As shown in Table 1, results made by using sesolve can be obtained. The result with the right side marked with “order0” represents the result of zeroth-order trotter, and the others are the results of second-order trotter. The number of the single-qubit states in the multi-qubit model can be determined. As the number of states increases, the time interval values become smaller, leading to longer runtime. The results obtained from sesolve can be used as a standard. Within an acceptable accuracy range (e.g., 10⁻⁴), a set of parameters that can balance accuracy and time consumption can be selected. For example, the parameters including the single-qubit 1 (Q1) being 3, the coupler being 8, the single-qubit 2 (Q2) being 3, and the time interval (n_slot_per_ns) being 100 can be selected as the parameters of a 3 Q model, and the frequency corresponding to the model can be determined based on the time interval.

TABLE 1
3-qubit model state parameter reference data

| | | | Time | |
|---|---|---|---|---|
| Q1 | coupler | Q2 | interval | Fidelity |
| 8 | 16 | 8 | / | 0.998567520194688 |
| 8 | 16 | 8 | 30 | 0.9985658270876208 (order0) |
| 8 | 16 | 8 | 30 | 0.9553726013089112 |
| 8 | 16 | 8 | 100 | 0.9985450034078043 |
| 8 | 16 | 8 | 80 | 0.9985218646961663 |
| 6 | 12 | 6 | 80 | 0.9985229462050497 |
| 5 | 10 | 5 | 80 | 0.9985236764224941 |
| 4 | 8 | 4 | 80 | 0.9984617979422845 |
| 4 | 8 | 4 | 100 | 0.998510392472311 |
| 4 | 8 | 4 | 150 | 0.9985533609596458 |
| 3 | 6 | 3 | 150 | 0.9647398468780495 |
| 3 | 7 | 3 | 150 | 0.9951809731015211 |
| 3 | 8 | 3 | 150 | 0.9985714043449339 |
| 2 | 8 | 2 | 150 | 0.9983638135227422 |
| 3 | 8 | 3 | 100 | 0.9985318863393428 |
| 3 | 8 | 3 | 80 | 0.9984882296980923 |

As shown in Table 1, if the frequency of the environmental qubit gates is determined as 3, and the frequency of the coupler is determined as 8 in the parameter selecting reference table, because the fidelity corresponding to the frequency of the environmental qubit gates and the frequency of the coupler in the parameter selecting reference table is 0.998531, the fidelity of the two-qubit gate can be determined as 0.998531. The above numbers are used only for illustrative purposes, without specific limitations.

In some embodiments, the real local extremum may be determined based on the offset local extremum. The frequency of the environmental qubit gates corresponding to the fidelity error of the environmental qubit gates can be determined based on the real local extremum. The fidelity corresponding to the frequency of the environmental qubit gates can be determined as the fidelity of the two-qubit gate.

For example, FIG. 9 is a schematic diagram of the fidelity of a 15-qubit model (15 Q model) according to some embodiments of the present disclosure. As shown in FIG. 9, diagonal striped points represent global maximum values, while black points represent bad points with the fidelity significantly lower than the fidelity of surrounding points. We found that within the illustrated range, there are two maximum value points: (0.426, 35, 0.890727) and (0.423, 45, 0.921256). The extremum point (0.426, 35, 0.890727) of the 15 Q model has a problem of significant extremum point offset compared with the extremum point (0.43, 32, 0.998568) of the 3 Q model. Therefore, the full-space maximum value point shown in FIG. 9 is not an original extremum point. Considering the limitation of coherence time, the extremum point near t=32 may be selected as the maximum value point without considering parameters satisfying conditions in the environmental qubits.

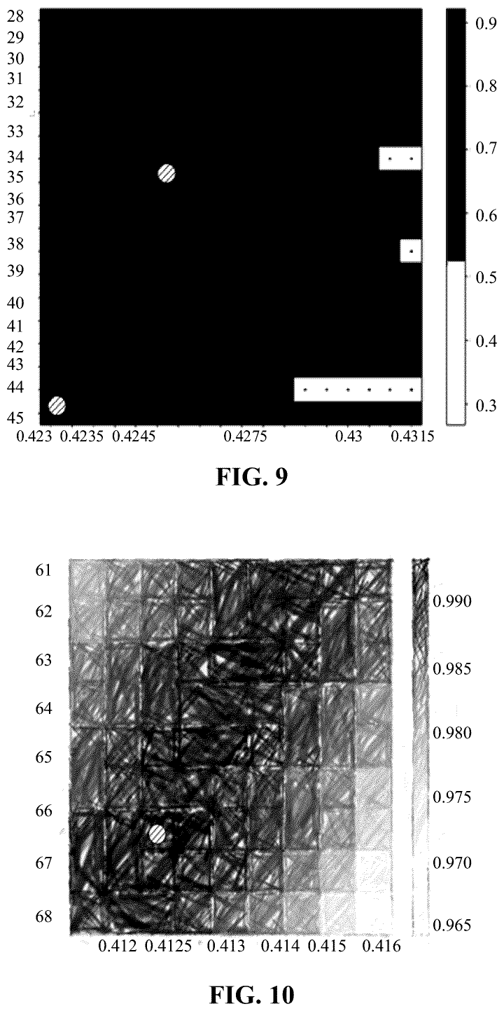

Due to the significant offset of the pre-determined extremum point of this type of superconducting circuit, the extremum point within the offset local extremum may not represent the real local extremum, and may be only located on the boundary without representing the real extremum point, and the real local extremum may be determined based on the maximum value point (0.423, 45, 0.921256). The range of the above maximum value point is expanded. FIG. 10 is a schematic diagram of a maximum value enlarging result according to some embodiments of the present disclosure. As shown in FIG. 10, the real local extremum (0.413, 66, 0.9910813) can be found after range expanding. Based on the real local extremum, the frequency of the environmental qubit gates corresponding to the fidelity error of the environmental qubit gates can be determined, and the fidelity corresponding to the frequency of the environmental qubit gates can be determined as the fidelity of the two-qubit gate.

In some embodiments, the multiple parameters include a basis vector. An evolution result of the quantum processor in the basis vector can be determined, and based on the evolution result, the frequency of the environmental qubit gates corresponding to the fidelity error of the environmental qubit gates can be determined.

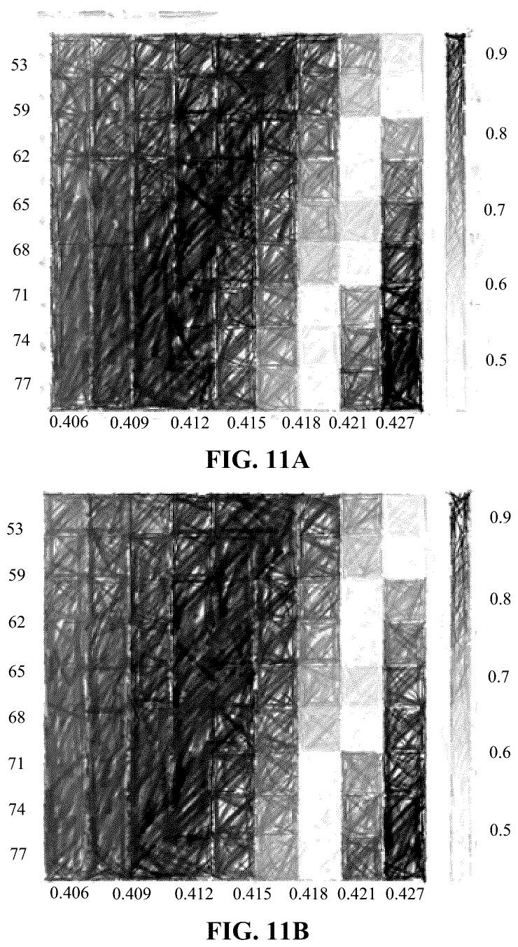

For example, FIG. 11A is a schematic diagram of an evolution result according to some embodiments of the present disclosure. FIG. 11A shows the evolution result of a 7 Q model in the product basis vector. FIG. 11B is a schematic diagram of another evolution result according to some embodiments of the present disclosure. FIG. 11B shows the evolution result of the 7 Q model in the eigen basis vector. In the above two figures, the horizontal axis represents text string parameters, and the vertical axis represents numerical values of gate operation parameters. The selection of basis vectors does not have a significant impact on the trend of fidelity changes. The maximum value in FIG. 11A is (0.43, 77, 0.996171), the maximum value in FIG. 11B is (0.43, 77, 0.997159), and the error is at the magnitude of 0.001. If actual measurement is performed in the eigen basis, the evolution result may be the evolution result in the eigen basis vector.

For another example, transformation matrices u_b3q_to_b3 and u_b7q_to_b7 between the product basis vector and the eigen basis vector can be provided in advance for the multi-qubit types of 3 Q and 7 Q. The transformation matrix may be denoted by U. For any matrix A, a basis vector transformation operation can be based on the following formula:

A_{EIGEN}=U^{†}A_{PRODUCT}U

where A_{EIGEN} may denote a matrix obtained after basis vector transformation, U^{†} may denote a conjugate transpose matrix of the transformation matrix, and A_{PRODUCT} may denote a matrix in the product basis vector. Due to the process of time evolution, the interaction between two qubits cannot be decomposed in the eigen basis vector into a simple direct product form of single-qubit states. Therefore, it is necessary to transform from the eigen basis vector to the product basis vector for the time evolution. For example, if the initial state is denoted by |φ [symbol] , the final state can be denoted based on:

|φ′ [symbol] _{EIGEN}=U_{EIGEN}(t)|φ [symbol] _{EIGEN}=U^{†}U_{PRODUCT}(t)U|φ [symbol] _{EIGEN}

The above may be implemented in the program as follows: the initial state in the eigen basis vector is set as |φ [symbol] _{EIGEN}, and is transformed by the transformation matrix U into the product basis vector U|φ [symbol] _{EIGEN}, time evolution U_{PRODUCT}U|φ [symbol] _{EIGEN} is performed by the trotter process, and finally a result is transformed back to the eigen basis vector U^{†}U_{PRODUCT}U|φ [symbol] _{EIGEN} to obtain the evolution result in the eigen basis vector.

It is to be noted that, a transformation matrix from the eigen space to the product space in the multi-qubit type is used during eigen-product space transformation. Due to the lack of a sorting operation on u_b*t_to_b*, during eigen-product space transformation, u_b*q_to_b* in the multi-qubit type may be used instead of u_b*t_to_b*, thereby improving the efficiency and accuracy of the transformation.

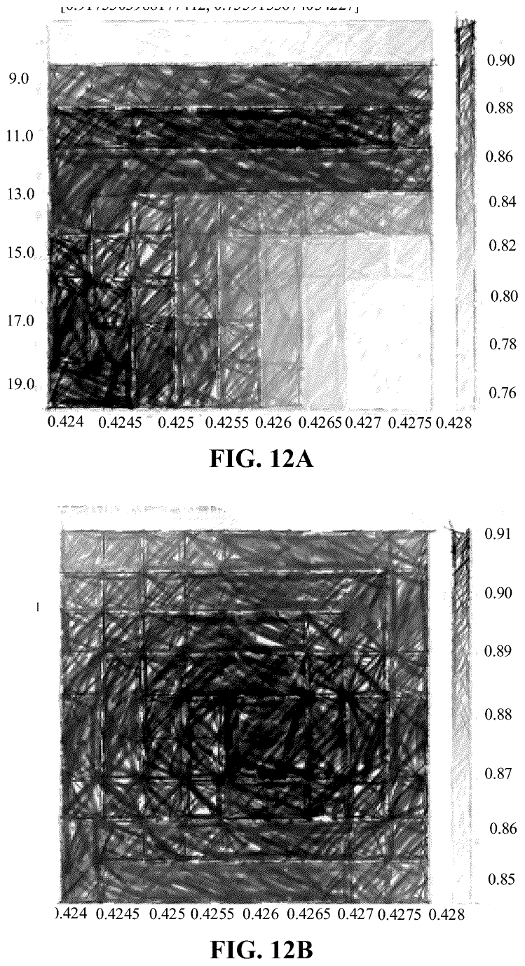

In some embodiments, FIG. 12A is a schematic diagram of another evolution result according to some embodiments of the present disclosure, and shows another evolution result of the 7 Q model in the eigen basis vector. The local maximum value point 33 is selected at t. Two local maximum values are found from a wide range of a two-dimensional variable. Therefore, waveform parameters satisfying conditions may be selected from parameters satisfying conditions without considering the environmental qubits, that is, the maximum value points nearby sigma=7.

In some embodiments, regarding the determination of phase modulation, it may be specified as follows: only the relative phase of diagonal elements of the evolution matrix of the two-qubit gate is considered. Generally, it can be written based on the following form:

$$U = ( \begin{matrix}1 & & & \\ & {e}^{{θ}_{2}} & & \\ & & {e}^{{θ}_{1}} & \\ & & & {e}^{φ + {θ}_{1} + {θ}_{2}}\end{matrix} )$$

Where φ denotes CZphase, and θ₁ and θ₂ may respectively represent angles of time evolution for a first data qubit and a second data qubit without considering interactions.

Therefore, by determining the relative phase of four elements on a diagonal line of the evolution matrix, the CZphase of the evolution matrix can be obtained. Based on the desired gate operation, determine CZphase=π.

Further, error analysis can be performed on the extremum points near sigma=7. FIG. 12B is a schematic diagram of another evolution result according to some embodiments of the present disclosure, and may show the evolution result of the 7 Q model in the eigen basis vector. The local maximum value is (0.426, 7.0, 0.909772).

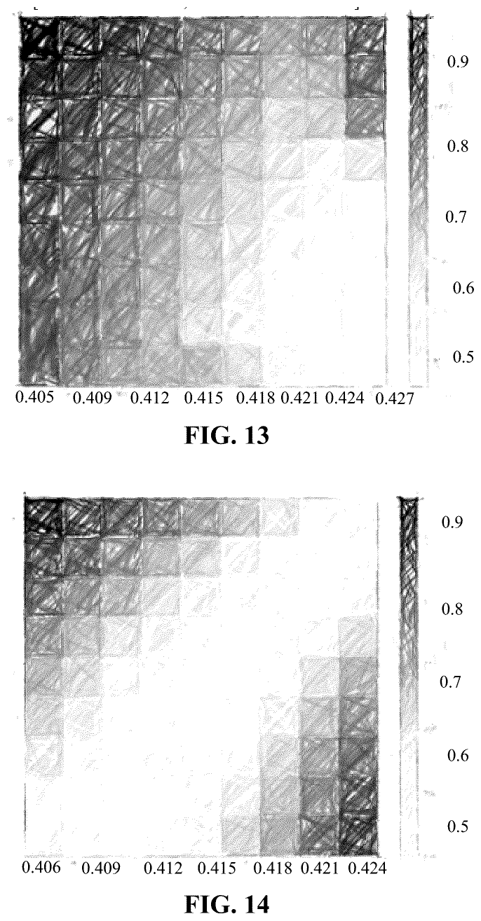

Error analysis is performed on the extremum points. FIG. 13 is a schematic diagram of leakage information of an evolution result according to some embodiments of the present disclosure. As shown in FIG. 13, the maximum value in the leakage information of the evolution result within the same range as the evolution result is located at the upper left corner, and is (0.424, 5.4, 0.237816), and the minimum value is located at the lower right corner, and is (0.428, 8.6, 0.165885). FIG. 14 is a schematic diagram of a difference of phase modulation according to some embodiments of the present disclosure. As shown in FIG. 14, a difference between phase modulation of the above evolution result within the range and π(or −π) is determined with the unit being π. The upper left region is represented by positive values (close to πt), and the lower right region is represented by negative values (close to −π). The values in the figure closer to 0 indicate better effects. Therefore, the maximum value and the minimum value in the positive region are respectively (0.994814, 0.735788), and the maximum value and the minimum value in the negative region are respectively (−0.768197, −0.999719).

Then, leakage information components at the maximum value (0.426, 7.0, 0.909772) can be analyzed, czphase=0.988097 π, and leakage=0.199811. Table 2 is an analysis table for leakage information components of various qubits. According to Table 2, the component with the highest leakage information is the second environmental qubit gate transitioning to the state 1 with a significantly higher probability compared to other components. It is to be noted that the total leakage and the leakage of several qubit states are not calculated using the same algorithm, and therefore the sum of the leakage of the several qubit states is not equal to the total leakage.

TABLE 2
Analysis table for leakage components of various qubits

| | Environmental | Environmental | Central | Environmental | Environmental |
|---|---|---|---|---|---|
| Fidelity | qubit | coupler | coupler | coupler | qubit |
| 0.909772 | 0.00276649 | 0.0009638880 | 0.0027336025 | 0.0003516626 | 0.34210881 |

A computational matrix of the maximum component is extracted, and matrix elements are observed, thereby determining that maximum probability leakage happens at two processes |001(0000) [symbol] →|000(0001) [symbol] and |101(0000) [symbol] →|100(0001) [symbol] . Among the seven numbers, the first and third positions represent the state of a central qubit, the second position represents the state of a central coupler, the fourth and sixth positions represent the state of an environmental coupler, and the fifth and seventh positions represent the state of the environmental qubits.

$$[ \begin{matrix}1.79 e - 04 - 5.39 e - 05 j & 5.17 e - 03 + 9.46 e - 03 j & 8.13 e - 04 + 2. e - 03 j & 6.45 e - 04 - 2.2 e - 04 j \\ 2.16 e - 01 + 3.89 e - 01 j & - 1.44 e - 04 + 1.06 e - 04 j & 8.6 e - 05 + 4.38 e - 04 j & 7.09 e - 04 - 2.18 e - 03 j \\ - 8.9 e - 04 + 1.51 e - 02 j & 3.03 e - 05 + 2.59 e - 05 j & 2.12 e - 04 - 4.51 e - 04 j & 2.44 e - 03 + 5.49 e - 03 j \\ 8.8 e - 06 - 3.91 e - 05 j & - 5.33 e - 03 - 8.92 e - 03 j & 1.57 e - 01 + 3.45 e - 01 j & 6.03 e - 04 - 4.08 e - 05 j\end{matrix} ]$$

For another example, for a two-qubit gate evolution matrix U, the initial state v of any data qubit is selected, satisfying v^{†}v=1, and the final state is given by Uv. By using an optimization algorithm (e.g., a gradient descent algorithm), v is found in a parameter space to satisfy

$$L = {min}_{v} ( {v}^{†} {U}^{†} Uv ) ,$$

thereby determining the total leakage being (1−L), where L may represent the probability of a given environmental qubit leaking to a specific final state.

Meanwhile, in order to calculate the magnitude of leakage for the given environmental qubit, a leakage channel may be set, such as |00ₑ [symbol] →|01ₑ [symbol] . The four final states (|00 [symbol] , |01 [symbol] , |10 [symbol] , and |11 [symbol] ) of the two-qubit gate evolution matrix will be transformed into the corresponding four final states (|00(01ₑ) [symbol] , |01(01ₑ) [symbol] , |10(01ₑ) [symbol] , and |11(01ₑ) [symbol] ), thereby extracting the four initial states (|00(00ₑ) [symbol] , |01(00ₑ) [symbol] , |10(00ₑ) [symbol] , and |11(00ₑ) [symbol] ) from the full-space evolution matrix to correspond to 16 matrix elements of new four final states (|00(01ₑ) [symbol] , |01(01ₑ) [symbol] , |10(01ₑ) [symbol] , and |11(01ₑ) [symbol] ) to form a 4*4 matrix U, and then calculate based on the following formula:

L=tr(U^{†}U)

where, the value of L may represent the probability of the given environmental qubit leaking to a specific final state. The evolution matrix may be based on the following form:

$$\begin{matrix}\vert 00 ( {00}_{e} ) 〉 \\ \vert 01 ( {00}_{e} ) 〉 \\ \vert 10 ( {00}_{e} ) 〉 \\ \vert 11 ( {00}_{e} ) 〉\end{matrix} {( \begin{matrix} & & & \\ & & & \\ & & & \\ & & & \end{matrix} )}^{\begin{matrix}\vert 00 ( {01}_{e} ) 〉 & \vert 01 ( {01}_{e} ) 〉 & \vert 10 ( {01}_{e} ) 〉 & \vert 11 ( {01}_{e} ) 〉\end{matrix}}$$

Based on the above calculation method, the probability of the given environmental qubit leaking to the specific final state can be determined, so as to determine the total leakage.

In some embodiments of the present disclosure, the influence on the two-qubit gate from the environmental qubit gates associated with the two-qubit gate in the quantum processor is considered. The fidelity is redefined, the fidelity error of the two-qubit gate is decomposed into different environmental qubit gates, and guidance is provided for selecting the frequency of the environmental qubit gates, thereby determining the fidelity satisfying conditions, achieving the technical effect of improving the accuracy of determining the fidelity of the two-qubit gate, and solving the technical problem of being unable to determine the fidelity of the two-qubit gate.

It is to be noted that to simplify the description, the foregoing method examples are described as a series of action combinations. But it is appreciated that the present disclosure is not limited to any described sequence of actions, as some steps can be executed in other sequences or executed at the same time according to the present disclosure. In addition, it is appreciated that all the examples described in the specification are preferred examples, and the related actions and modules are not necessary to the present disclosure.

As can be appreciated from some embodiments described above that the method may be implemented by relying on software and a commodity hardware platform or by using hardware. Based on such an understanding, the technical solutions of the present disclosure essentially, or the part contributing to the prior art may be presented in the form of a software product. The computer software product is stored in a storage medium (e.g., a read-only memory (ROM)/random access memory (RAM), a magnetic disk, and an optical disc), and includes several instructions to enable a terminal device (e.g., a mobile phone, a computer, a server, or a network device) to perform the methods described in the examples of the present disclosure.

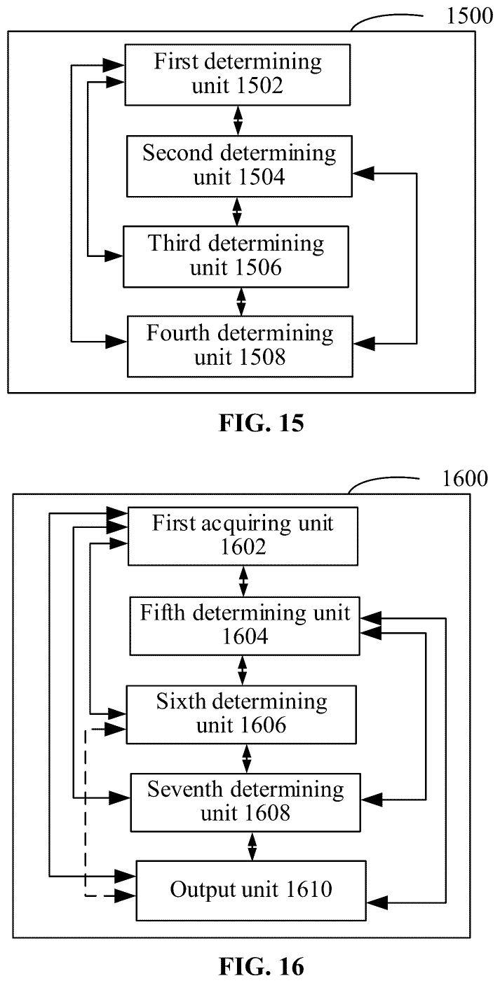

FIG. 15 is a schematic diagram of an example apparatus for determining fidelity of a qubit gate in a quantum chip for implementing the method for determining fidelity of a qubit gate in a quantum chip shown in FIG. 4, according to some embodiments of the present disclosure. As shown in FIG. 15, the apparatus 1500 for determining the fidelity of the qubit gate in the quantum chip may include: a first determining unit 1502, a second determining unit 1504, a third determining unit 1506, and a fourth determining unit 1508.

The first determining unit 1502 is configured to determine environmental qubit gates associated with a two-qubit gate in a quantum processor, where the two-qubit gate interacts with the environmental qubit gates in the quantum processor.

The second determining unit 1504 is configured to determine a fidelity error of the environmental qubit gates based on a fidelity error of the two-qubit gate.

The third determining unit 1506 is configured to determine frequency of the environmental qubit gates based on the fidelity error of the environmental qubit gates.

The fourth determining unit 1508 is configured to determine fidelity of the two-qubit gate based on the frequency of the environmental qubit gates.

Herein, it is to be noted that, the first determining unit 1502, the second determining unit 1504, the third determining unit 1506, and the fourth determining unit 1508 correspond to steps S402 to S408, as described above. The examples and application scenarios implemented by the four units and the corresponding steps are the same, but are not limited to the content disclosed in these embodiments. It is to be noted that, the above units may be hardware components or software components stored in a memory (e.g., a memory 104) and processed by one or more processors (e.g., processors 102a, 102b, . . . , and 102n). These units may also be a part of the apparatus to run on the computer terminal 100 provided in some embodiments of the present disclosure.

Some embodiments of the present disclosure further provides an apparatus for determining fidelity of a qubit gate in a quantum chip for implementing the method for determining fidelity of a qubit gate in a quantum chip shown in FIG. 5.

FIG. 16 is a schematic diagram of an example apparatus for determining fidelity of a qubit gate in a quantum chip according to some embodiments of the present disclosure. As shown in FIG. 16, the apparatus 1600 for determining the fidelity of the qubit gate in the quantum chip may include: a first acquiring unit 1602, a fifth determining unit 1604, a sixth determining unit 1606, a seventh determining unit 1608, and an output unit 1610.

The first acquiring unit 1602 is configured to acquire, by invoking a first interface, environmental qubit gates associated with a two-qubit gate in a quantum processor, where the first interface includes a first parameter, a parameter value of the first parameter involves the two-qubit gate and the environmental qubit gates, and the two-qubit gate interacts with the environmental qubit gates in the quantum processor.

The fifth determining unit 1604 is configured to determine a fidelity error of the environmental qubit gates based on a fidelity error of the two-qubit gate.

The sixth determining unit 1606 is configured to determine frequency of the environmental qubit gates based on the fidelity error of the environmental qubit gates.

The seventh determining unit 1608 is configured to determine fidelity of the two-qubit gate based on the frequency of the environmental qubit gates.

The output unit 1610 is configured to output the fidelity of the two-qubit gate by invoking a second interface, where the second interface includes a second parameter, and a parameter value of the second parameter represents the fidelity of the two-qubit gate.

Herein, it is to be noted that, the first acquiring unit 1602, the fifth determining unit 1604, the sixth determining unit 1606, the seventh determining unit 1608, and the output unit 1610 correspond to steps S502 to S510, as described above. The examples and application scenarios implemented by the five units and the corresponding steps are the same, but are not limited to the content disclosed in these embodiments. It is to be noted that, the above units may be hardware components or software components stored in a memory (e.g., a memory 104) and processed by one or more processors (e.g., processors 102a, 102b, . . . , and 102n). These units may also be a part of the apparatus to run on the computer terminal 100 provided in some embodiments of the present disclosure.

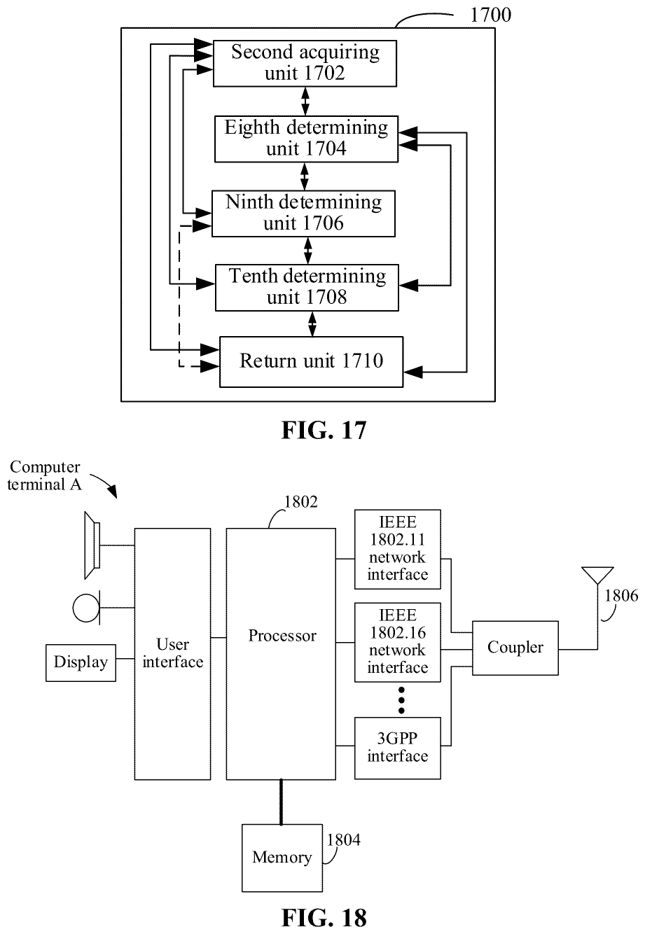

FIG. 17 is a schematic diagram of an example apparatus for determining fidelity of a qubit gate in a quantum chip for implementing the method for determining fidelity of a qubit gate in a quantum chip shown in FIG. 7, according to some embodiments of the present disclosure. As shown in FIG. 17, the apparatus 1700 for determining the fidelity of the qubit gate in the quantum chip may include: a second acquiring unit 1702, an eighth determining unit 1704, a ninth determining unit 1706, a tenth determining unit 1708, and a return unit 1710.

The second acquiring unit 1702 is configured to acquire, from a quantum platform, environmental qubit gates associated with a two-qubit gate in a quantum processor, where the two-qubit gate interacts with the environmental qubit gates in the quantum processor.

The eighth determining unit 1704 is configured to determine a fidelity error of the environmental qubit gates based on a fidelity error of the two-qubit gate.

The ninth determining unit 1706 is configured to determine frequency of the environmental qubit gates based on the fidelity error of the environmental qubit gates.

The tenth determining unit 1708 is configured to determine fidelity of the two-qubit gate based on the frequency of the environmental qubit gates.

The return unit 1710 is configured to return the fidelity of the two-qubit gate to the quantum platform.

Herein, it is to be noted that, the second acquiring unit 1702, the eighth determining unit 1704, the ninth determining unit 1706, the tenth determining unit 1708, and the return unit 1710 correspond to steps S702 to S710, as described above. The examples and application scenarios implemented by the five units and the corresponding steps are the same, but are not limited to the content disclosed in these embodiments. It is to be noted that, the above units may be hardware components or software components stored in a memory (e.g., a memory 104) and processed by one or more processors (e.g., processors 102a, 102b, . . . , and 102n). These units may also be a part of the apparatus to run on the computer terminal 100 provided in some embodiments of the present disclosure.

According to the apparatus for determining the fidelity of the qubit gate in the quantum chip in some embodiments, the influence on the two-qubit gate from the environmental qubit gates associated with the two-qubit gate in the quantum processor is considered. The fidelity is redefined, the fidelity error of the two-qubit gate is decomposed into different environmental qubit gates, and guidance is provided for selecting the frequency of the environmental qubit gates, thereby determining the fidelity satisfying conditions, achieving the technical effect of improving the accuracy of determining the fidelity of the two-qubit gate, and solving the technical problem of being unable to determine the fidelity of the two-qubit gate.

Some embodiments of the present disclosure may provide a computer terminal. The computer terminal may be any computer terminal device in a computer terminal cluster. In some embodiments, the above computer terminal may be replaced with terminal devices such as a mobile terminal.

In some embodiments, the above computer terminal may be located in at least one of a plurality of network devices in a computer network.

in some embodiments, the computer terminal may execute program code in an application program for performing the following steps of the method for determining fidelity of a qubit gate in a quantum chip: environmental qubit gates associated with a two-qubit gate in a quantum processor are determined, where the two-qubit gate interacts with the environmental qubit gates in the quantum processor; a fidelity error of the environmental qubit gates is determined based on a fidelity error of the two-qubit gate; frequency of the environmental qubit gates is determined based on the fidelity error of the environmental qubit gates; and fidelity of the two-qubit gate is determined based on the frequency of the environmental qubit gates.

FIG. 18 is a structural block diagram of an example computer terminal according to some embodiments of the present disclosure. As shown in FIG. 18, the computer terminal A may include: one or more processors 1802 (only one is shown in the figure), a memory 1804, and a transmission apparatus 1806.

The memory may be configured to store software programs and modules, such as program instructions/modules corresponding to the method and apparatus for determining fidelity of a qubit gate in a quantum chip in some embodiments of the present disclosure. The processor performs, by running the software programs and the modules stored in the memory, various functional applications and predictions, thereby implementing the above method for determining fidelity of a qubit gate in a quantum chip. The memory may include a high-speed random memory, and may also include a non-volatile memory, such as one or more magnetic storage apparatuses, a flash memory, or another nonvolatile solid-state memory. For example, the memory may further include memories remotely disposed relative to the processor, and these remote memories may be connected to the computer terminal A through networks. Examples of the network include, but are not limited to, the Internet, an intranet, a local area network, a mobile communication network, and a combination thereof.

The processor may perform the following steps by invoking, through the transmission apparatus, the information and application programs stored in the memory: environmental qubit gates associated with a two-qubit gate in a quantum processor are determined, where the two-qubit gate interacts with the environmental qubit gates in the quantum processor; a fidelity error of the environmental qubit gates is determined based on a fidelity error of the two-qubit gate; frequency of the environmental qubit gates is determined based on the fidelity error of the environmental qubit gates; and fidelity of the two-qubit gate is determined based on the frequency of the environmental qubit gates.

In some embodiments, the processor may further perform program code of the following step: the fidelity error of the two-qubit gate is decomposed into different environmental qubit gates, thereby obtaining the fidelity error of the different environmental qubit gates.

In some embodiments, the processor may further perform program code of the following step: a superconducting circuit of the quantum processor is scanned to obtain multiple parameters; and the frequency of the environmental qubit gates corresponding to the fidelity error of the environmental qubit gates is determined based on the multiple parameters.

In some embodiments, the processor may further perform program code of the following step: the frequency of the environmental qubit gates and frequency of a coupler corresponding to the fidelity error of the environmental qubit gates are determined based on the single-qubit parameters; and the fidelity of the two-qubit gate is determined based on the frequency of the environmental qubit gates and the frequency of the coupler.

In some embodiments, the processor may further perform program code of the following step: the frequency of the environmental qubit gates and the frequency of the coupler corresponding to the fidelity error of the environmental qubit gates are determined based on the number of the single-qubit states in the multi-qubit model; and the fidelity corresponding to the frequency of the environmental qubit gates and the frequency of the coupler is determined as the fidelity of the two-qubit gate.

In some embodiments, the processor may further perform program code of the following step: a real local extremum is determined based on the offset local extremum; the frequency of the environmental qubit gates corresponding to the fidelity error of the environmental qubit gates is determined based on the real local extremum; and the fidelity corresponding to the frequency of the environmental qubit gates is determined as the fidelity of the two-qubit gate.

In some embodiments, the processor may further perform program code of the following step: an evolution result of the quantum processor in the basis vector is determined; and the frequency of the environmental qubit gates corresponding to the fidelity error of the environmental qubit gates is determined based on the evolution result, where a magnitude of the fidelity error of the environmental qubit gates is less than a magnitude threshold.

In some embodiments, the processor may further perform program code of the following step: the frequency of the environmental qubit gates corresponding to the fidelity error of the environmental qubit gates is determined based on the waveform parameters.

In some embodiments, the processor may further perform program code of the following steps: leakage information of the quantum processor at the local maximum value is determined; and a qubit state to which the environmental qubit gates corresponding to the leakage information transition jumps, and the frequency of the environmental qubit gates corresponding to the fidelity error of the environmental qubit gates in the qubit state are determined. The step of determining fidelity of the two-qubit gate based on the frequency of the environmental qubit gates includes: the fidelity corresponding to the frequency of the environmental qubit gates is determined as the fidelity of the two-qubit gate.

In some embodiments, the processor may perform the following steps by invoking, through the transmission apparatus, the information and application programs stored in the memory: environmental qubit gates associated with a two-qubit gate in the quantum processor are acquired by invoking a first interface, where the first interface includes a first parameter, a parameter value of the first parameter involves the two-qubit gate and the environmental qubit gates, and the two-qubit gate interacts with the environmental qubit gates in the quantum processor; a fidelity error of the environmental qubit gates is determined based on a fidelity error of the two-qubit gate; frequency of the environmental qubit gates is determined based on the fidelity error of the environmental qubit gates; fidelity of the two-qubit gate is determined based on the frequency of the environmental qubit gates; and the fidelity of the two-qubit gate is outputted by invoking a second interface, where the second interface includes a second parameter, and a parameter value of the second parameter represents the fidelity of the two-qubit gate.

In some embodiments, the processor may perform the following steps by invoking, through the transmission apparatus, the information and application programs stored in the memory: environmental qubit gates associated with a two-qubit gate in the quantum processor are acquired from a quantum platform, where the two-qubit gate interacts with the environmental qubit gates in the quantum processor; a fidelity error of the environmental qubit gates is determined based on a fidelity error of the two-qubit gate; frequency of the environmental qubit gates is determined based on the fidelity error of the environmental qubit gates; fidelity of the two-qubit gate is determined based on the frequency of the environmental qubit gates; and the fidelity of the two-qubit gate is returned to the quantum platform.

In some embodiments of the present disclosure, the influence on the two-qubit gate from the environmental qubit gates associated with the two-qubit gate in the quantum processor is considered. The fidelity is redefined, the fidelity error of the two-qubit gate is decomposed into different environmental qubit gates, and guidance is provided for selecting the frequency of the environmental qubit gates, thereby determining the fidelity satisfying conditions, achieving the technical effect of improving the accuracy of determining the fidelity of the two-qubit gate, and solving the technical problem of being unable to determine the fidelity of the two-qubit gate.

It is appreciated that the structure shown in FIG. 18 is only illustrative. The computer terminal A may also be a terminal device such as a smartphone (e.g., a tablet, a palmtop computer, and mobile Internet devices (MIDs)), and PAD. FIG. 18 does not limit the structure of the above computer terminal A. For example, the computer terminal A may further include more or fewer components (e.g., a network interface and a display apparatus) than those shown in FIG. 18, or has a configuration different from that shown in FIG. 18.

It is appreciated that all or some of steps of various methods in the foregoing examples may be implemented by a program instructing related hardware of the terminal device. The program may be stored in a computer-readable storage medium. The storage medium may include: a flash drive, a Read-Only Memory (ROM), a Random Access Memory (RAM), a magnetic disk, an optical disc, and the like.

Some embodiments of the present disclosure further provides a computer-readable storage medium. In some embodiments, the computer-readable storage medium may be configured to store program code for performing the method for determining fidelity of a qubit gate in a quantum chip in some embodiments of the present disclosure.

In some embodiments, the computer-readable storage medium may be located in any computer terminal within a computer terminal cluster in a computer network or in any mobile terminal within a mobile terminal cluster.

In some embodiments, the computer-readable storage medium may be configured to store program code used for performing the following steps: environmental qubit gates associated with a two-qubit gate in a quantum processor are determined, where the two-qubit gate interacts with the environmental qubit gates in the quantum processor; a fidelity error of the environmental qubit gates is determined based on a fidelity error of the two-qubit gate; frequency of the environmental qubit gates is determined based on the fidelity error of the environmental qubit gates; and fidelity of the two-qubit gate is determined based on the frequency of the environmental qubit gates.

In some embodiments, the computer-readable storage medium may further perform program code of the following steps: a superconducting circuit of the quantum processor is scanned to obtain multiple parameters; and the frequency of the environmental qubit gates corresponding to the fidelity error of the environmental qubit gates is determined based on the multiple parameters.

In some embodiments, the computer-readable storage medium may further perform program code of the following steps: the frequency of the environmental qubit gates and frequency of a coupler corresponding to the fidelity error of the environmental qubit gates are determined based on the single-qubit parameters; and the fidelity of the two-qubit gate is determined based on the frequency of the environmental qubit gates and the frequency of the coupler.

In some embodiments, the computer-readable storage medium may further perform program code of the following steps: the frequency of the environmental qubit gates and the frequency of the coupler corresponding to the fidelity error of the environmental qubit gates are determined based on the number of the single-qubit states in the multi-qubit model; and the fidelity corresponding to the frequency of the environmental qubit gates and the frequency of the coupler is determined as the fidelity of the two-qubit gate.

In some embodiments, the computer-readable storage medium may further perform program code of the following steps: a real local extremum is determined based on the offset local extremum; the frequency of the environmental qubit gates corresponding to the fidelity error of the environmental qubit gates is determined based on the real local extremum; and the fidelity corresponding to the frequency of the environmental qubit gates is determined as the fidelity of the two-qubit gate.

In some embodiments, the computer-readable storage medium may further perform program code of the following steps: an evolution result of the quantum processor in the basis vector is determined; and the frequency of the environmental qubit gates corresponding to the fidelity error of the environmental qubit gates is determined based on the evolution result, where a magnitude of the fidelity error of the environmental qubit gates is less than a magnitude threshold.

In some embodiments, the computer-readable storage medium may further perform program code of the following step: the frequency of the environmental qubit gates corresponding to the fidelity error of the environmental qubit gates is determined based on the waveform parameters.

In some embodiments, the computer-readable storage medium may further perform program code of the following steps: leakage information of the quantum processor at the local maximum value is determined; and a qubit state to which the environmental qubit gates corresponding to the leakage information transition jumps, and the frequency of the environmental qubit gates corresponding to the fidelity error of the environmental qubit gates in the qubit state are determined. The step of determining fidelity of the two-qubit gate based on the frequency of the environmental qubit gates includes: the fidelity corresponding to the frequency of the environmental qubit gates is determined as the fidelity of the two-qubit gate.

In some embodiments, the computer-readable storage medium is configured to store program code used for performing the following steps: environmental qubit gates associated with a two-qubit gate in the quantum processor are acquired by invoking a first interface, where the first interface includes a first parameter, a parameter value of the first parameter involves the two-qubit gate and the environmental qubit gates, and the two-qubit gate interacts with the environmental qubit gates in the quantum processor; a fidelity error of the environmental qubit gates is determined based on a fidelity error of the two-qubit gate; frequency of the environmental qubit gates is determined based on the fidelity error of the environmental qubit gates; fidelity of the two-qubit gate is determined based on the frequency of the environmental qubit gates; and the fidelity of the two-qubit gate is outputted by invoking a second interface, where the second interface includes a second parameter, and a parameter value of the second parameter represents the fidelity of the two-qubit gate.

In some embodiments, the computer-readable storage medium is configured to store program code used for performing the following steps: environmental qubit gates associated with a two-qubit gate in the quantum processor are acquired from a quantum platform, where the two-qubit gate interacts with the environmental qubit gates in the quantum processor; a fidelity error of the environmental qubit gates is determined based on a fidelity error of the two-qubit gate; frequency of the environmental qubit gates is determined based on the fidelity error of the environmental qubit gates; fidelity of the two-qubit gate is determined based on the frequency of the environmental qubit gates; and the fidelity of the two-qubit gate is returned to the quantum platform.

The sequence numbers of the foregoing examples of the present disclosure are merely for the description purpose but do not imply the preference among the examples.

In the foregoing examples of the present disclosure, the descriptions of the examples have respective focuses. For a part that is not described in detail in an example, refer to related descriptions in other examples.

In the several examples provided in the present disclosure, it is to be understood that the disclosed technical content may be implemented in other manners. The above described apparatus examples are merely illustrative, such as unit division which is merely logical function division, and during practical implementation, there may be additional division manners. For example, a plurality of units or assemblies may be combined or integrated into another system, or some characteristics may be ignored or not executed. In addition, the coupling, or direct coupling, or communication connection between the displayed or discussed components may be the indirect coupling or communication connection by means of some interfaces, units, or modules, and may be electrical or of other forms.

The units described as separate components may or may not be physically separated, and components displayed as units may or may not be physical units, that is, may be located in one position, or may be distributed on a plurality of network units. Some or all of the units may be selected according to actual needs to achieve the objectives of the solutions of the examples.

In addition, functional units in the examples of the present disclosure may be integrated into one processing unit, or each of the units may be physically separated, or two or more units may be integrated into one unit. The integrated unit may be implemented in the form of hardware, or may be implemented in a form of a software functional unit.

If the integrated unit is implemented in the form of the software functional unit and sold or used as an independent product, the integrated unit may be stored in a computer-readable storage medium. Based on such an understanding, the technical solutions of the present disclosure essentially, or the part contributing to the prior art, or all or some of the technical solutions may be embodied in the form of a software product. The computer software product is stored in a storage medium and includes several instructions for instructing a computer device (e.g., a personal computer, a server, or a network device) to perform all or some of the steps of the methods described in the examples of the present disclosure. The foregoing storage medium includes: a USB flash drive, a read-only memory (ROM), a random access memory (RAM), a portable hard disk drive, a magnetic disk, an optical disc, or various media that can store program code.

The embodiments may further be described using the following clauses:
1. A method for determining fidelity of a qubit gate in a quantum processor, including:
determining environmental qubit gates associated with a two-qubit gate in the quantum processor, wherein the two-qubit gate interacts with the environmental qubit gates in the quantum processor;
determining a fidelity error of the environmental qubit gates based on a fidelity error of the two-qubit gate;
determining frequency of the environmental qubit gates based on the fidelity error of the environmental qubit gates; and
determining fidelity of the two-qubit gate based on the frequency of the environmental qubit gates.
2. The method according to clause 1, wherein determining the fidelity error of the environmental qubit gates based on the fidelity error of the two-qubit gate includes: decomposing the fidelity error of the two-qubit gate into different environmental qubit gates, so as to obtain the fidelity error of the different environmental qubit gates.
3. The method according to clause 1 or 2, wherein determining the frequency of the environmental qubit gates based on the fidelity error of the environmental qubit gates includes:
scanning a superconducting circuit of the quantum processor to obtain a plurality of parameters; and
determining the frequency of the environmental qubit gates corresponding to the fidelity error of the environmental qubit gates based on the plurality of parameters.
4. The method according to clause 3, wherein the plurality of parameters include single-qubit parameters, wherein determining the frequency of the environmental qubit gates corresponding to the fidelity error of the environmental qubit gates based on the plurality of parameters includes:
determining the frequency of the environmental qubit gates and frequency of a coupler corresponding to the fidelity error of the environmental qubit gates based on the single-qubit parameters; and
wherein determining fidelity of the two-qubit gate based on the frequency of the environmental qubit gates includes: determining the fidelity of the two-qubit gate based on the frequency of the environmental qubit gates and the frequency of the coupler.
5. The method according to clause 3, wherein the plurality of parameters include a number of single-qubit states in a multi-qubit model, wherein determining the frequency of the environmental qubit gates corresponding to the fidelity error of the environmental qubit gates based on the plurality of parameters includes:
determining the frequency of the environmental qubit gates and frequency of a coupler corresponding to the fidelity error of the environmental qubit gates based on the number of the single-qubit states in the multi-qubit model; and
determining fidelity of the two-qubit gate based on the frequency of the environmental qubit gates includes: determining a fidelity corresponding to the frequency of the environmental qubit gates and the frequency of the coupler as the fidelity of the two-qubit gate.

6. The method according to clause 3, wherein the plurality of parameters include an offset local extremum, wherein determining the frequency of the environmental qubit gates corresponding to the fidelity error of the environmental qubit gates based on the plurality of parameters includes:
determining a real local extremum based on the offset local extremum; and
determining the frequency of the environmental qubit gates corresponding to the fidelity error of the environmental qubit gates based on the real local extremum; and
determining fidelity of the two-qubit gate based on the frequency of the environmental qubit gates includes: determining a fidelity corresponding to the frequency of the environmental qubit gates as the fidelity of the two-qubit gate.
7. The method according to clause 3, wherein the plurality of parameters include a basis vector, wherein determining the frequency of the environmental qubit gates corresponding to the fidelity error of the environmental qubit gates based on the plurality of parameters includes:
determining an evolution result of the quantum processor in the basis vector; and
determining the frequency of the environmental qubit gates corresponding to the fidelity error of the environmental qubit gates based on the evolution result, wherein a magnitude of the fidelity error of the environmental qubit gates is less than a magnitude threshold.
8. The method according to clause 7, wherein the plurality of parameters include waveform parameters, and the waveform parameters are maximum value points determined based on the evolution result, wherein determining the frequency of the environmental qubit gates corresponding to the fidelity error of the environmental qubit gates based on the plurality of parameters includes:
determining the frequency of the environmental qubit gates corresponding to the fidelity error of the environmental qubit gates based on the waveform parameters.
9. The method according to clause 7, wherein the plurality of parameters include a local maximum value of the evolution result, wherein determining the frequency of the environmental qubit gates corresponding to the fidelity error of the environmental qubit gates based on the plurality of parameters includes:
determining leakage information of the quantum processor at the local maximum value; and
determining a qubit state to which the environmental qubit gates corresponding to the leakage information transition jumps, and determining the frequency of the environmental qubit gates corresponding to the fidelity error of the environmental qubit gates in the qubit state; and
determining fidelity of the two-qubit gate based on the frequency of the environmental qubit gates includes: determining the fidelity corresponding to the frequency of the environmental qubit gates as the fidelity of the two-qubit gate.
10. The method according to any of clauses 1 to 9, wherein the quantum processor includes inductively-coupled fluxonium-type qubits, or the quantum processor includes transmon-type qubits.
11. A method for determining fidelity of a qubit gate in a quantum processor, including:
acquiring, by invoking a first interface, environmental qubit gates associated with a two-qubit gate in the quantum processor, wherein the first interface includes a first parameter, a value of the first parameter involves the two-qubit gate and the environmental qubit gates, wherein the two-qubit gate interacts with the environmental qubit gates in the quantum processor;
determining a fidelity error of the environmental qubit gates based on a fidelity error of the two-qubit gate;
determining frequency of the environmental qubit gates based on the fidelity error of the environmental qubit gates;
determining fidelity of the two-qubit gate based on the frequency of the environmental qubit gates; and
outputting, by invoking a second interface, the fidelity of the two-qubit gate, wherein the second interface includes a second parameter, and a value of the second parameter represents the fidelity of the two-qubit gate.
12. A method for determining fidelity of a qubit gate in a quantum processor, including:
acquiring, from a quantum platform, environmental qubit gates associated with a two-qubit gate in the quantum processor, wherein the two-qubit gate interacts with the environmental qubit gates in the quantum processor;
determining a fidelity error of the environmental qubit gates based on a fidelity error of the two-qubit gate;
determining frequency of the environmental qubit gates based on the fidelity error of the environmental qubit gates;
determining fidelity of the two-qubit gate based on the frequency of the environmental qubit gates; and
returning the fidelity of the two-qubit gate to the quantum platform.
13. An apparatus for determining fidelity of a qubit gate in a quantum processor, including:
a memory storing instructions; and
one or more processors configured to execute the instructions to cause the apparatus to perform operations including:
   determining environmental qubit gates associated with a two-qubit gate in the quantum processor, wherein the two-qubit gate interacts with the environmental qubit gates in the quantum processor;
   determining a fidelity error of the environmental qubit gates based on a fidelity error of the two-qubit gate;
   determining frequency of the environmental qubit gates based on the fidelity error of the environmental qubit gates; and
   determining fidelity of the two-qubit gate based on the frequency of the environmental qubit gates.

14. An apparatus for determining fidelity of a qubit gate in a quantum processor, including:
a memory storing instructions; and
one or more processors configured to execute the instructions to cause the apparatus to perform operations including:
   acquiring, by invoking a first interface, environmental qubit gates associated with a two-qubit gate in the quantum processor, wherein the first interface includes a first parameter, a parameter value of the first parameter involves the two-qubit gate and the environmental qubit gates, wherein the two-qubit gate interacts with the environmental qubit gates in the quantum processor;
   determining a fidelity error of the environmental qubit gates based on a fidelity error of the two-qubit gate;
   determining frequency of the environmental qubit gates based on the fidelity error of the environmental qubit gates;
   determining fidelity of the two-qubit gate based on the frequency of the environmental qubit gates; and
   outputting, by invoking a second interface, the fidelity of the two-qubit gate, wherein the second interface includes a second parameter, and a parameter value of the second parameter represents the fidelity of the two-qubit gate.

15. An apparatus for determining fidelity of a qubit gate in a quantum processor, including:
a memory storing instructions; and
one or more processors configured to execute the instructions to cause the apparatus to perform operations including:
   acquiring, from a quantum platform, environmental qubit gates associated with a two-qubit gate in the quantum processor, wherein the two-qubit gate interacts with the environmental qubit gates in the quantum processor;
   determining a fidelity error of the environmental qubit gates based on a fidelity error of the two-qubit gate;
   determining frequency of the environmental qubit gates based on the fidelity error of the environmental qubit gates;
   determining fidelity of the two-qubit gate based on the frequency of the environmental qubit gates; and
   returning the fidelity of the two-qubit gate to the quantum platform.
16. A non-transitory computer-readable storage medium storing a set of instructions that are executable by one or more processors of a device to cause the device to perform operations for determining fidelity of a qubit gate in a quantum chip, the operations including:
determining environmental qubit gates associated with a two-qubit gate in the quantum processor, wherein the two-qubit gate interacts with the environmental qubit gates in the quantum processor;
determining a fidelity error of the environmental qubit gates based on a fidelity error of the two-qubit gate;
determining frequency of the environmental qubit gates based on the fidelity error of the environmental qubit gates; and
determining fidelity of the two-qubit gate based on the frequency of the environmental qubit gates.
17. A processor, configured to operate programs, the programs, when operated by the processor, performing operations for determining fidelity of a qubit gate in a quantum chip, the operations including:
determining environmental qubit gates associated with a two-qubit gate in the quantum processor, wherein the two-qubit gate interacts with the environmental qubit gates in the quantum processor;
determining a fidelity error of the environmental qubit gates based on a fidelity error of the two-qubit gate;
determining frequency of the environmental qubit gates based on the fidelity error of the environmental qubit gates; and
determining fidelity of the two-qubit gate based on the frequency of the environmental qubit gates.

It is to be noted that, the terms such as “first” and “second” in the specification and claims of this disclosure and the above accompanying drawings are used for distinguishing similar objects but not necessarily used for describing particular order or sequence. It is to be understood that such used data is interchangeable where appropriate so that the examples of this disclosure described here can be implemented in an order other than those illustrated or described here. Moreover, the terms “include”, “have” and any other variants thereof mean to cover the non-exclusive inclusion. For example, a process, method, system, product, or device that includes a list of steps or units is not necessarily limited to those expressly listed steps or units, but may include other steps or units not expressly listed or inherent to such a process, method, system, product, or device.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

It should be understood that the disclosed technical content may be implemented in other ways. The apparatus embodiments described above are only schematic. For example, the division of the units is only a logical function division. In actual implementations, there may be another division manner. For example, multiple units or components may be combined or integrated into another system, or some features can be ignored or not implemented. In addition, the displayed or discussed mutual coupling or direct coupling or communication connection may be indirect coupling or communication connection through some interfaces, units, or modules, which may be in electrical or other forms.

The units described as separate components may or may not be physically separated, and the components displayed as units may or may not be physical units, that is, they may be located in one place or may be distributed to a plurality of network units. Part of or all the units may be selected according to actual needs to achieve the purpose of the solution of the present embodiment.

In addition, the functional units in various embodiments of the present disclosure may be integrated into one processing unit, or each unit may exist alone physically, or two or more units may be integrated into one unit. The integrated units described above may be implemented either in the form of hardware or in the form of a software functional unit.

If the integrated units are implemented in the form of a software functional unit and sold or used as an independent product, they may be stored in a quantum computer-readable storage medium. Based on such an understanding, the technical solutions of the present disclosure essentially, or the part making contributions to the prior art, or all or part of the technical solutions may be embodied in the form of a software product. The quantum computer software product is stored in a storage medium and includes several instructions used for causing a quantum computer device to execute all or part of steps of the methods in various embodiments of the present disclosure.

The foregoing descriptions are merely preferred implementations of the present disclosure. It is to be noted that a plurality of improvements and refinements may be made by those of ordinary skill in the technical field without departing from the principle of the present disclosure, and shall fall within the scope of protection of the present disclosure.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method for determining fidelity of a qubit gate in a quantum processor, comprising:
determining environmental qubit gates associated with a two-qubit gate in the quantum processor, wherein the two-qubit gate interacts with the environmental qubit gates in the quantum processor;
determining a fidelity error of the environmental qubit gates based on a fidelity error of the two-qubit gate;
determining frequency of the environmental qubit gates based on the fidelity error of the environmental qubit gates; and
determining fidelity of the two-qubit gate based on the frequency of the environmental qubit gates.

2. The method according to claim 1, wherein determining the fidelity error of the environmental qubit gates based on the fidelity error of the two-qubit gate comprises:
decomposing the fidelity error of the two-qubit gate into different environmental qubit gates, so as to obtain the fidelity error of the different environmental qubit gates.

3. The method according to claim 1, wherein determining the frequency of the environmental qubit gates based on the fidelity error of the environmental qubit gates comprises:
scanning a superconducting circuit of the quantum processor to obtain a plurality of parameters; and
determining the frequency of the environmental qubit gates corresponding to the fidelity error of the environmental qubit gates based on the plurality of parameters.

4. The method according to claim 3, wherein the plurality of parameters comprise single-qubit parameters, wherein determining the frequency of the environmental qubit gates corresponding to the fidelity error of the environmental qubit gates based on the plurality of parameters comprises:
determining the frequency of the environmental qubit gates and frequency of a coupler corresponding to the fidelity error of the environmental qubit gates based on the single-qubit parameters; and
wherein determining fidelity of the two-qubit gate based on the frequency of the environmental qubit gates comprises: determining the fidelity of the two-qubit gate based on the frequency of the environmental qubit gates and the frequency of the coupler.

5. The method according to claim 3, wherein the plurality of parameters comprise a number of single-qubit states in a multi-qubit model, wherein determining the frequency of the environmental qubit gates corresponding to the fidelity error of the environmental qubit gates based on the plurality of parameters comprises:
determining the frequency of the environmental qubit gates and frequency of a coupler corresponding to the fidelity error of the environmental qubit gates based on the number of the single-qubit states in the multi-qubit model; and
determining fidelity of the two-qubit gate based on the frequency of the environmental qubit gates comprises: determining a fidelity corresponding to the frequency of the environmental qubit gates and the frequency of the coupler as the fidelity of the two-qubit gate.

6. The method according to claim 3, wherein the plurality of parameters comprise an offset local extremum, wherein determining the frequency of the environmental qubit gates corresponding to the fidelity error of the environmental qubit gates based on the plurality of parameters comprises:
determining a real local extremum based on the offset local extremum; and
determining the frequency of the environmental qubit gates corresponding to the fidelity error of the environmental qubit gates based on the real local extremum; and
determining fidelity of the two-qubit gate based on the frequency of the environmental qubit gates comprises: determining a fidelity corresponding to the frequency of the environmental qubit gates as the fidelity of the two-qubit gate.

7. The method according to claim 3, wherein the plurality of parameters comprise a basis vector, wherein determining the frequency of the environmental qubit gates corresponding to the fidelity error of the environmental qubit gates based on the plurality of parameters comprises:
determining an evolution result of the quantum processor in the basis vector; and
determining the frequency of the environmental qubit gates corresponding to the fidelity error of the environmental qubit gates based on the evolution result, wherein a magnitude of the fidelity error of the environmental qubit gates is less than a magnitude threshold.

8. The method according to claim 7, wherein the plurality of parameters comprise waveform parameters, and the waveform parameters are maximum value points determined based on the evolution result, wherein determining the frequency of the environmental qubit gates corresponding to the fidelity error of the environmental qubit gates based on the plurality of parameters comprises:
determining the frequency of the environmental qubit gates corresponding to the fidelity error of the environmental qubit gates based on the waveform parameters.

9. The method according to claim 7, wherein the plurality of parameters comprise a local maximum value of the evolution result, wherein determining the frequency of the environmental qubit gates corresponding to the fidelity error of the environmental qubit gates based on the plurality of parameters comprises:
determining leakage information of the quantum processor at the local maximum value; and
determining a qubit state to which the environmental qubit gates corresponding to the leakage information transition jumps, and determining the frequency of the environmental qubit gates corresponding to the fidelity error of the environmental qubit gates in the qubit state; and
determining fidelity of the two-qubit gate based on the frequency of the environmental qubit gates comprises: determining the fidelity corresponding to the frequency of the environmental qubit gates as the fidelity of the two-qubit gate.

10. The method according to claim 1, wherein the quantum processor comprises inductively-coupled fluxonium-type qubits, or the quantum processor comprises transmon-type qubits.

11. A method for determining fidelity of a qubit gate in a quantum processor, comprising:
acquiring, by invoking a first interface, environmental qubit gates associated with a two-qubit gate in the quantum processor, wherein the first interface comprises a first parameter, a parameter value of the first parameter involves the two-qubit gate and the environmental qubit gates, wherein the two-qubit gate interacts with the environmental qubit gates in the quantum processor;
determining a fidelity error of the environmental qubit gates based on a fidelity error of the two-qubit gate;
determining frequency of the environmental qubit gates based on the fidelity error of the environmental qubit gates;
determining fidelity of the two-qubit gate based on the frequency of the environmental qubit gates; and
outputting, by invoking a second interface, the fidelity of the two-qubit gate, wherein the second interface comprises a second parameter, and a parameter value of the second parameter represents the fidelity of the two-qubit gate.

12. A method for determining fidelity of a qubit gate in a quantum processor, comprising:
acquiring, from a quantum platform, environmental qubit gates associated with a two-qubit gate in the quantum processor, wherein the two-qubit gate interacts with the environmental qubit gates in the quantum processor;
determining a fidelity error of the environmental qubit gates based on a fidelity error of the two-qubit gate;
determining frequency of the environmental qubit gates based on the fidelity error of the environmental qubit gates;
determining fidelity of the two-qubit gate based on the frequency of the environmental qubit gates; and
returning the fidelity of the two-qubit gate to the quantum platform.
